(19) United States
(12) Patent Application Publication
(10) Pub. No.: US 2025/0327340 A1
(43) Pub. Date: Oct. 23, 2025

(54) LOCK CYLINDER

(71) Applicant: Pacific Lock Company, Valencia, CA (US)

(72) Inventors: Gregory Boylan Waugh, Stevenson Ranch, CA (US); David Larry Freiberg, Valencia, CA (US); Samuel John Fossa, Newhall, CA (US)

(73) Assignee: Pacific Lock Company, Valencia, CA (US)

(21) Appl. No.: 19/186,374

(22) Filed: Apr. 22, 2025

Related U.S. Application Data
(60) Provisional application No. 63/637,032, filed on Apr. 22, 2024.

(51) Int. Cl. E05B 67/22; E05B 31/00

(52) U.S. Cl. CPC E05B 67/22; E05B 31/00

(57) ABSTRACT

A universal lock cylinder with a housing that houses a rotating disc detainer. The universal lock cylinder is self-contained. The universal lock cylinder may comprise an integral shackle and may comprise of two pieces. The universal lock cylinder is detachably associated with a protective lock casing. An outer surface of the housing of the universal lock cylinder is configured commensurate with an inner surface of a case cylinder retainer opening of a protective lock casing.

### CROSS-REFERENCE TO RELATED APPLICATIONS

This Application claims the benefit of priority of co-pending U.S. Utility Provisional Patent Application 63/637,032, filed 22 Apr. 2024, the entire disclosure of which is expressly incorporated by reference in its entirety herein.

All documents mentioned in this specification are herein incorporated by reference to the same extent as if each individual document was specifically and individually indicated to be incorporated by reference.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

### Field of the Invention

One or more embodiments of the present invention are related to a locking device and, more particularly to an interchangeable lock cylinder form that uses rotating disc-detainer technology.

### Description of Related Art

Conventional locking devices with protective lock casings that enable interchangeability (or permitting mutual substitution) of different lock cylinder forms and lock cylinder technologies are well known. Non-limiting examples of such lock devices are disclosed in U.S. Pat. Nos. 8,776,557 and 8,978,426, both of which are assigned to the current assignee, Pacific Lock Company and incorporated by reference in their entirety herein.

Regrettably, most conventional lock devices do not include rotating disc-detainer (RDD) technology and for a few select that do use RDD technology, the number of actual discs used is low, providing significantly insufficient security where a high-level security locking system is required. The number of RDD discs used within the existing cylinder forms is limited due to the physical limitations (size, shape, etc.) of existing cylinders.

The following is a well-known formula that may be used to determine the number of lock combinations:

$$( {( position per disc )}^{( number of discs )} ) - 1 = number of combinations$$

For example, the best conventional RDD technology available that is used for pad locks have 11 discs with each disc having 6 positions, resulting in only 362,797,055 combinations, which is insufficient.

Further drawback with conventional locking devices that do allow interchangeability and do allow the use of RDD technology require the complex, cumbersome task by the end-user to assemble and disassemble the various components of the lock device to interchange one cylinder form of a particular lock cylinder technology for another cylinder form of a different lock cylinder technology.

Accordingly, considering the current state of the art and the drawbacks to current locking devices mentioned above, a need exists for an interchangeable lock cylinder having rotating disc-detainer technology that may be used with conventional protective lock casings, thus permitting mutual substitution (or interchangeability) of different lock cylinder forms having different lock cylinder technologies.

Further, a need exists for an interchangeable lock cylinder with a rotating disc-detainer technology that would be interchangeable, but without having to compel end-users to disassemble and reassemble various components of the lock device.

Further, a need exists for an interchangeable lock cylinder with a rotating disc-detainer technology that would allow the use of greater number of discs to significantly increase the overall security of a locking system.

### BRIEF SUMMARY OF THE INVENTION

A non-limiting, exemplary aspect of an embodiment of the present invention provides a lock device, comprising a universal lock cylinder that is self-contained and includes a housing with an integral rotating disc-detainer.

Another non-limiting, exemplary aspect of an embodiment of the present invention provides a lock device, comprising a universal lock cylinder that includes a housing with an integral rotating disc-detainer.

A lock device, comprising a universal lock cylinder that includes a housing with an integral rotating disc-detainer and shackle.

Yet another non-limiting, exemplary aspect of an embodiment of the present invention provides a lock device, comprising a universal lock cylinder that is isolated from a shackle assembly, wherein: the universal lock cylinder engages the shackle assembly by an interface.

A further non-limiting, exemplary aspect of an embodiment of the present invention provides a universal lock cylinder, comprising a housing comprised of a first piece and a second piece that houses a shackle; and an integral rotating disc detainer.

Another non-limiting, exemplary aspect of an embodiment of the present invention provides a universal lock cylinder, comprising a housing that accommodates a rotating disc detainer.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIG. 1 is a non-limiting, exemplary illustration of different types of well-known, conventional lock device casings that use a universal lock cylinder with rotating disc-detainer (RDD) technology in accordance with one or more embodiments of the present invention;

FIGS. 2A to 2E are non-limiting, exemplary illustrations that progressively detail installing and removing the universal lock cylinder with a well known, conventional protective casing illustrated in FIG. 1 to form a complete lock device in accordance with one or more embodiments of the present invention;

FIGS. 3A to 3H are non-limiting, exemplary illustrations of the various views of the universal lock cylinder of FIGS. 1 to 2E without casings in accordance with one or more embodiments of the present invention;

FIGS. 4A and 4B are non-limiting, exemplary cross-sectional view illustrations of the universal lock cylinder shown in FIGS. 1 to 3H in accordance with one or more embodiments of the present invention;

FIGS. 5A to 5H are non-limiting exemplary exploded view illustrations of the various components of the universal lock cylinder shown in FIGS. 1 to 4B in accordance with one or more embodiments of the present invention;

FIGS. 6A and 6N are non-limiting, exemplary illustrations of the various views of the first piece of the universal lock cylinder shown in FIGS. 1 to 5H in accordance with one or more embodiments of the present invention;

FIGS. 7A to 7E are non-limiting, exemplary illustrations of the various views of the second piece of the universal lock cylinder shown in FIGS. 1 to 6N in accordance with one or more embodiments of the present invention;

FIGS. 8A to 8D are non-limiting, exemplary illustrations of the various views of rotating disc detainer and FIGS. 8E to 8P are non-limiting, exemplary illustrations of the various views of a plug of the rotating disc-detainer of the universal lock cylinder shown in FIGS. 1 to 7E in accordance with one or more embodiments of the present invention;

FIGS. 9A to 100 are non-limiting, exemplary illustrations of a lock device with the universal lock cylinder illustrated in FIGS. 1 to 8P, but with a different shackle in accordance with another embodiment of the present invention;

FIGS. 11A-1 to 11R are non-limiting, exemplary illustrations of a lock device that uses a universal lock cylinder in accordance with another embodiment of the present invention; and

FIGS. 12A to 20E are non-limiting, exemplary illustrations of a lock device that uses a universal lock cylinder in accordance with another embodiment of the present invention, which may be used with non-hidden shackle or simply, padlock type lock devices.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

One or more embodiments of the present invention define lock cylinder (or simply, “cylinder”) in accordance with its ordinary meaning, which is an assembly comprised of a housing that includes a lock cylinder technology.

One or more embodiments of the present invention define lock cylinder form as the physical size and or shape, design, format, or style of a cylinder. Non-limiting, non-exhaustive listings of examples of cylinder forms (styles, designs, etc.) may include Small Format Interchangeable Core (SFIC), Key-in-Knob (Kik), T-handle (or tubular), etc.

One or more embodiments of the present invention define lock cylinder technology as the actual technology used in various lock cylinder forms.

Non-limiting, non-exhaustive listings of examples of cylinder technologies may include pin tumbler, wafer disc tumbler, rotating disc-detainer, etc. For example, pin tumbler technology may be used in both SFIC and Kik cylinder forms. As another example, rotating disc-detainer cylinder technology may be used in both Kik and T-handle cylinder forms.

One or more embodiments of the present invention provide an interchangeable lock cylinder form with a rotating disc-detainer technology that may be used with a conventional protective lock casing, thus permitting mutual substitution (or interchangeability) of different lock cylinder forms having different lock cylinder technology.

Further, one or more embodiments of the present invention provide an interchangeable lock cylinder form with a rotating disc-detainer technology that allows interchangeability, but without having to compel end-users to disassemble and reassemble various components of the lock device.

Further, one or more embodiments of the present invention provide an interchangeable lock cylinder form that allows the use of a greater number of discs (12 or more discs) to significantly increase the overall security of a locking system.

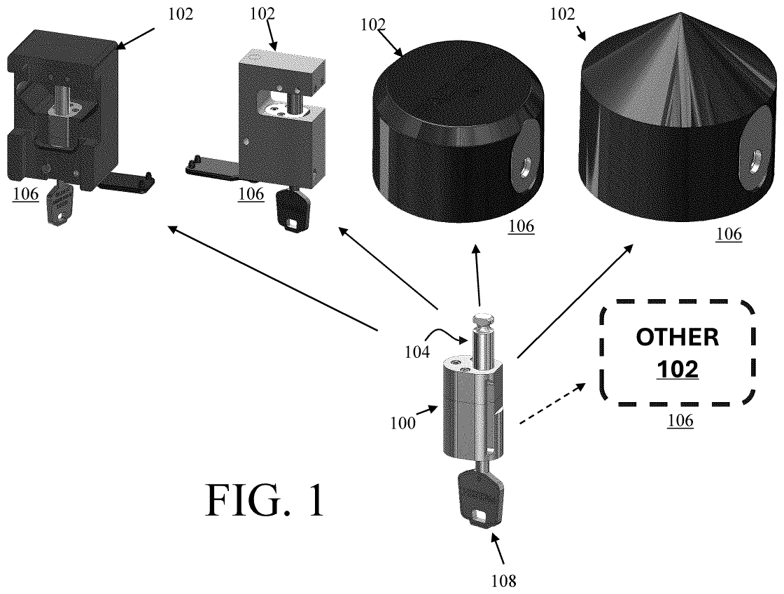

FIG. 1 is a non-limiting, exemplary illustration of different types of lock device casings that use a universal lock cylinder with rotating disc-detainer (RDD) technology in accordance with one or more embodiments of the present invention. Universal lock cylinder 100 may be detachably associated with different types of protective lock casings 102. In the non-limiting, exemplary instance, protective lock casings 102 shown are “hidden shackle types.” However, as further detailed below, the universality concept of a universal lock cylinder may also be easily extended to the non-hidden shackle types (e.g., a simple padlock with an exposed shackle).

Further, universal lock cylinder 100 may be interchangeable with different cylinder forms having different cylinder technologies in relation to a protective lock casing and as detailed below, no assembly is required. That is, interchangeability without having to compel end-users to disassemble and reassemble various components of lock device 106.

Universal lock cylinder 100 is self-contained and includes a housing with an integral RDD. In this non-limiting exemplary embodiment, universal lock cylinder 100 further includes an integrated shackle 104.

It should be noted that the RDD technology used in accordance with the present invention and disclosed throughout includes more than 11 discs (at least 12). For RDD with 12 discs for example, the number of combinations is 2,176,482,335.

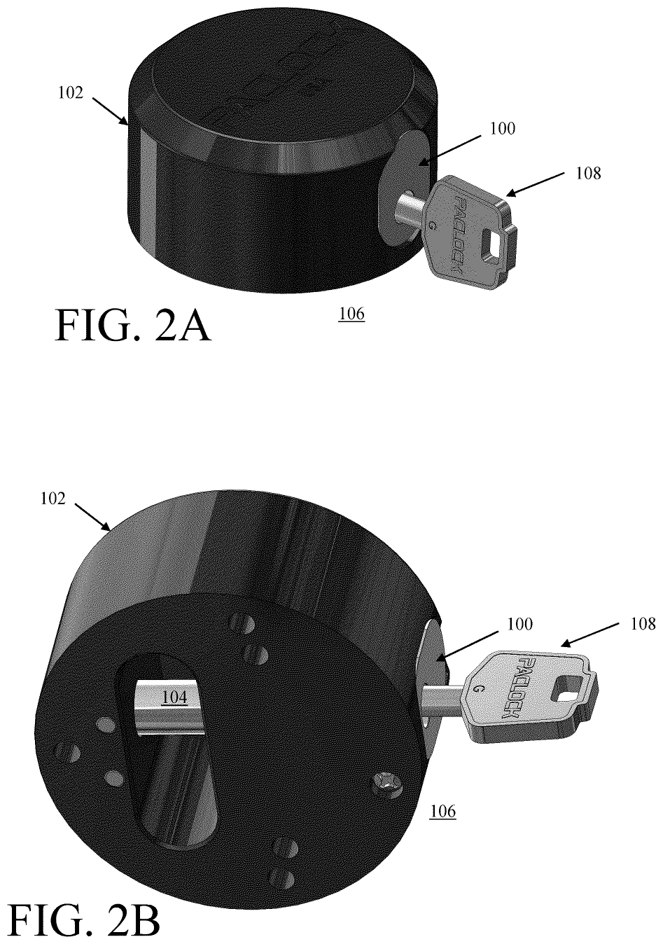

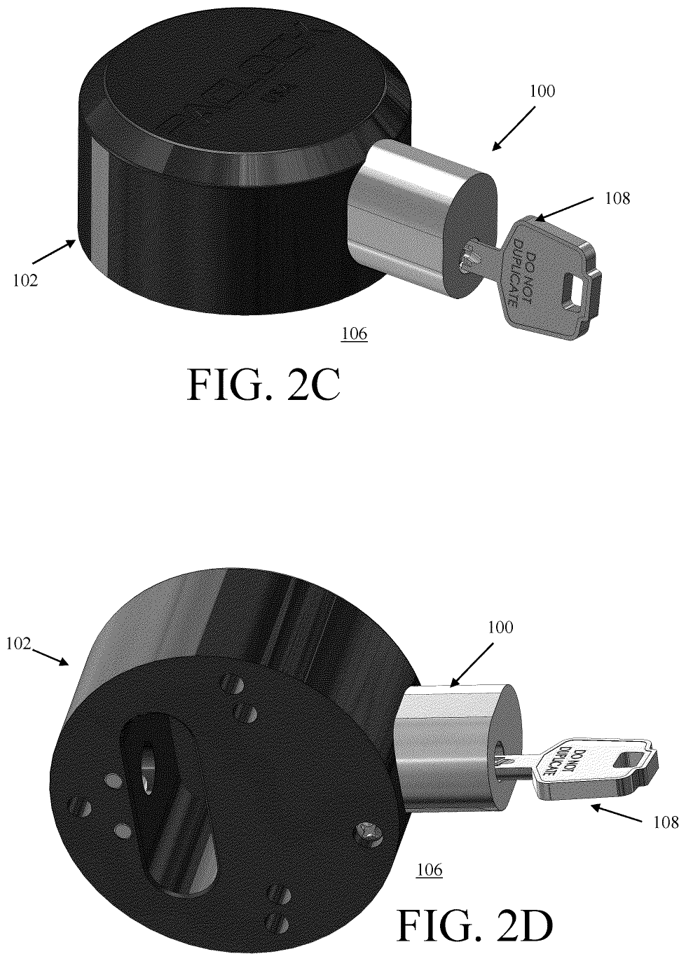

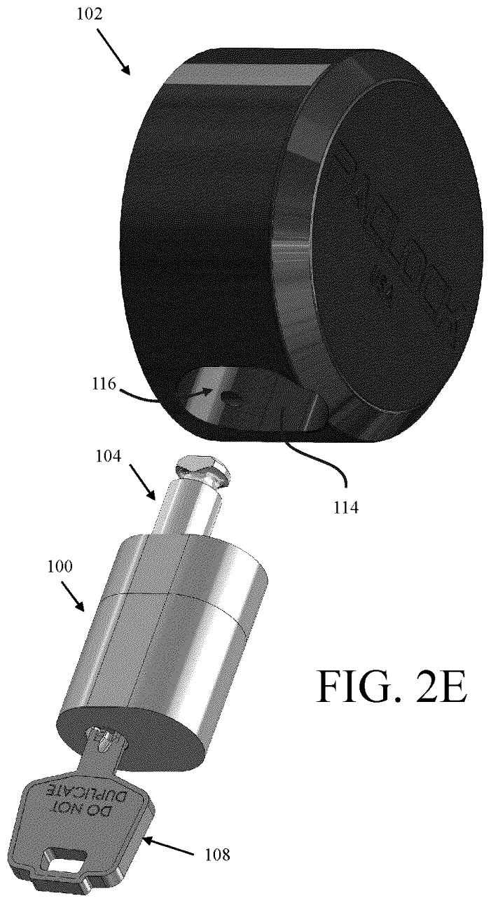

FIGS. 2A to 2E are non-limiting, exemplary illustrations that progressively detail installing and removing the universal lock cylinder with a well known, conventional protective casing illustrated in FIG. 1 to form a complete lock device in accordance with one or more embodiments of the present invention. It should be noted that it is only for clarity and brevity that only one protective lock casing 102 from FIG. 1 is randomly selected as a sample and described and as further detailed below, the details of the used sample casing 102 are equally applicable for all the other protective casings 102 shown in FIG. 1.

As best illustrated in FIGS. 2A to 2E, the overall operation of universal lock cylinder 100 is similar to currently existing conventional interchangeable cylinders with the exception that universal lock cylinder 100 has no sleeve, saving weight, part-count, assembly/disassembly, etc.

Universal lock cylinder 100 may be inserted and locked by a key 108, and may be unlocked by key 108 and removed in relation to protective lock casing 102 in well known manner with no learning curve for end-users and no need or requirements for handling unnecessary parts such as conventional sleeves.

Unlike most conventional lock systems, universal lock cylinder 100 has no need or requirement for disassembly and reassembly of various components of lock device 106 because universal lock cylinder 100 is modular and fully self-contained.

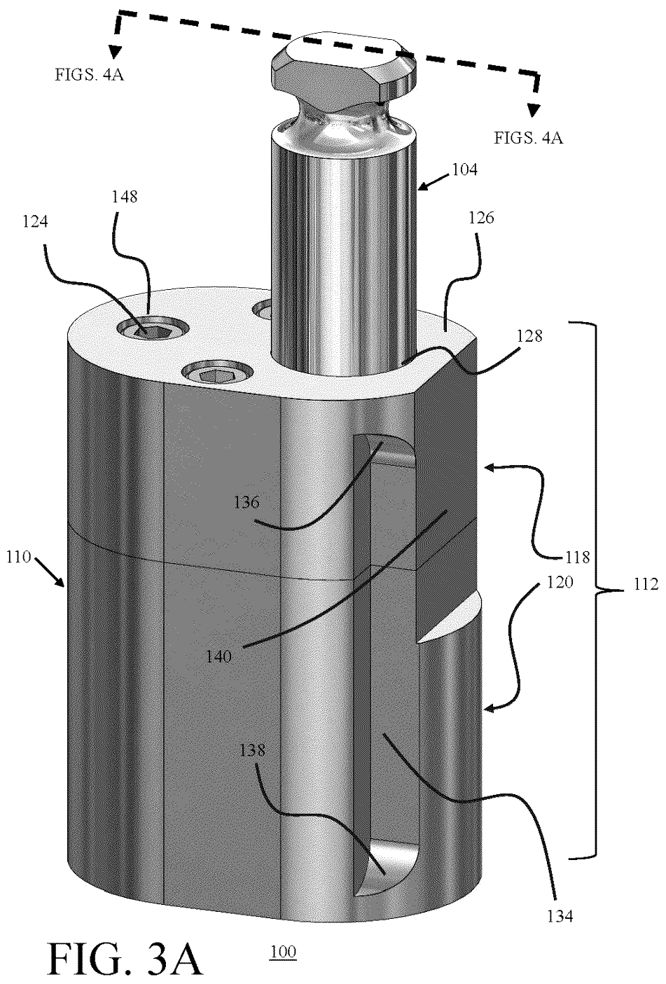

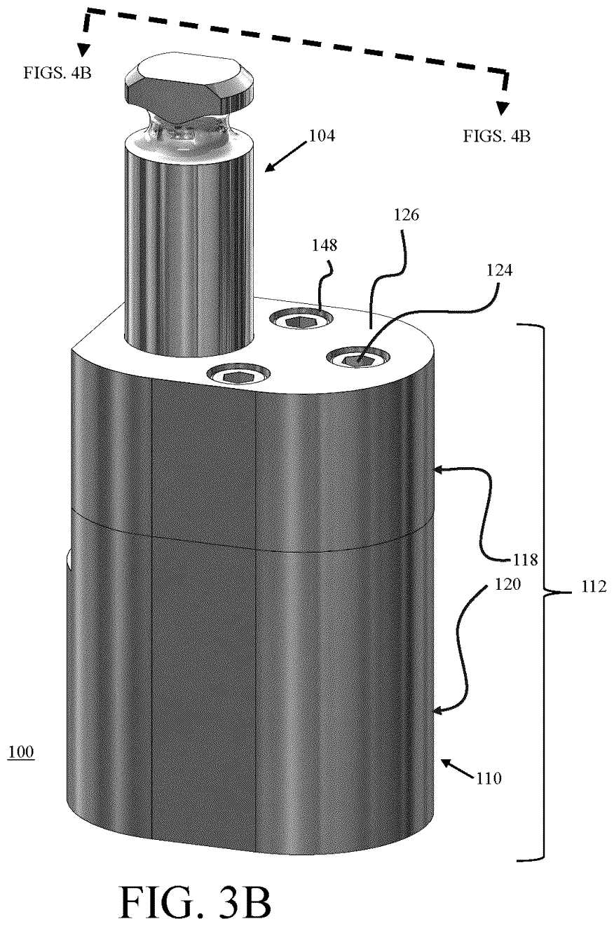

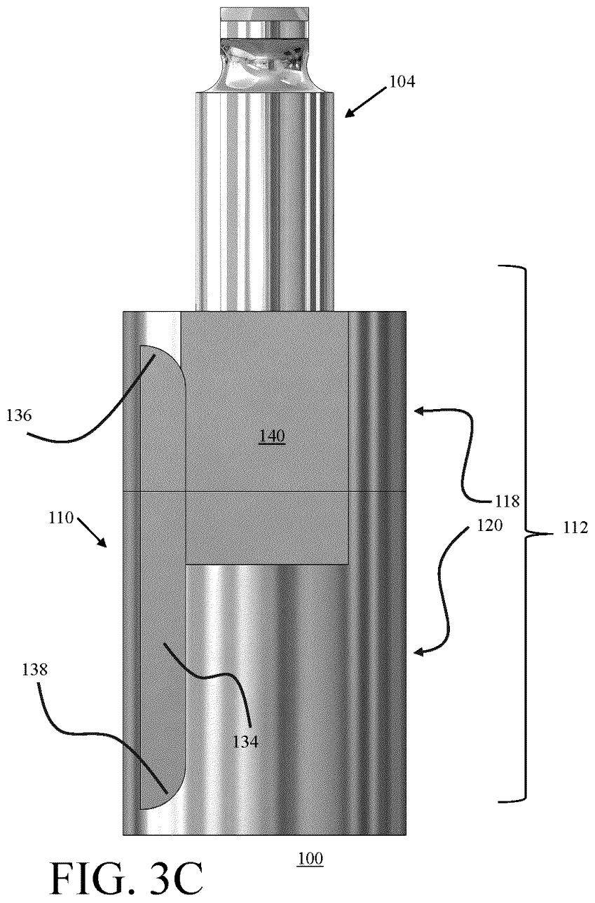

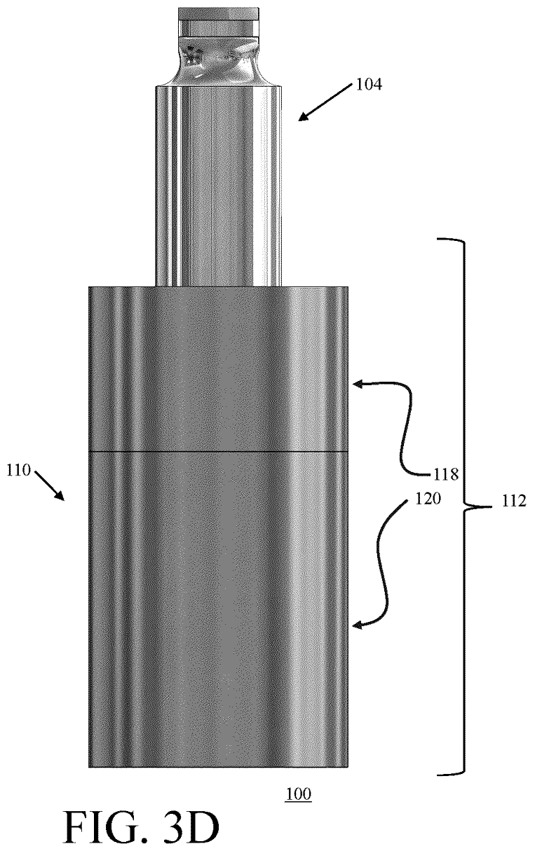

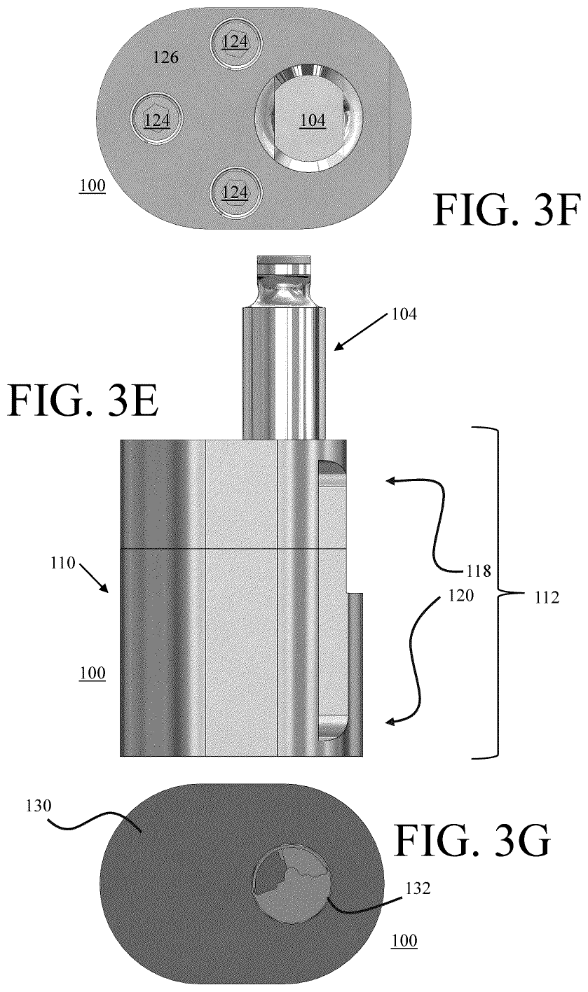

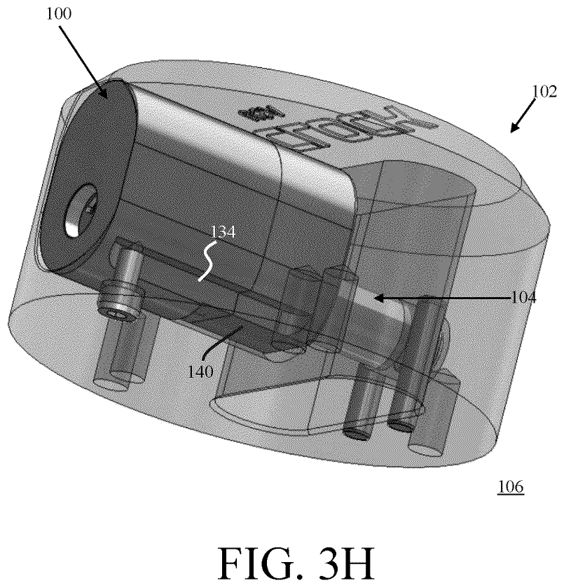

FIGS. 3A to 3H are non-limiting, exemplary illustrations of the various views of the universal lock cylinder of FIGS. 1 to 2E without casings in accordance with one or more embodiments of the present invention.

As illustrated in FIGS. 3A to 3H, an outer surface 110 of a housing 112 of universal lock cylinder 100 is configured to have mating surfaces with an inner surface 114 (FIG. 2E) of a case cylinder retainer opening 116 of protective lock casing 102.

More specifically, the term mating surfaces refers to surfaces that, at any location, may be substantially parallel to each other. That is, the tangent at any point on one surface (e.g., outer surface 110) is substantially parallel to a tangent from the corresponding point of the other surface (e.g., inner surface 114). For example, like a hand and glove relationship.

It should be noted that outer surface 110 of housing 112 illustrated should not be limiting and may be varied corresponding with inner surface 114 of a particular case cylinder retainer opening 116 of protective lock casing 102 with which it is to be associated. For example, protective lock casing 102 may have a square or other profile case cylinder retainer opening 116 for receiving universal lock cylinder 100 and hence, outer surface 110 of housing 112 may be configured to correspond to that shape or form.

In this non-limiting, exemplary embodiment, housing 112 of universal lock cylinder 100 is comprised of a first piece 118 and a second piece 120. An overall height and width of housing 112 is configured commensurate with an overall corresponding depth and width of case cylinder retainer opening 116.

Housing 112 may be comprised of at least one fastener opening 148 for a fastener 124 that secures first and second pieces 118 and 120 together to form housing 112.

Housing 112 may further be comprised of a top side 126 that has a shackle opening 158 through which shackle 104 of universal lock cylinder 100 extends. A bottom side 130 of housing 112 may have a key opening 132 for insertion of lock key 108.

Outer surface 110 of housing 112 may further be comprised of a retainer recessed cavity 134 with a first distal end wall 136 of cavity 134 used for preventing universal lock cylinder 100 from being removed from case cylinder retainer opening 116.

Retainer recessed cavity 134 has a second distal end wall 138 used for preventing universal lock cylinder 100 from moving too far into case cylinder retainer opening 116 of protective lock casing 102.

Outer surface 110 of housing 112 may further be comprised of a partially extending generally flat recessed section 140, which is provided for additional mating compatibility with particular types of protective lock casings 102. That is, case cylinder retainer opening 114 of some casings 102 may also include a partially extending flat, forming a parallel mating surface with the generally flat recessed section 140 of housing 112.

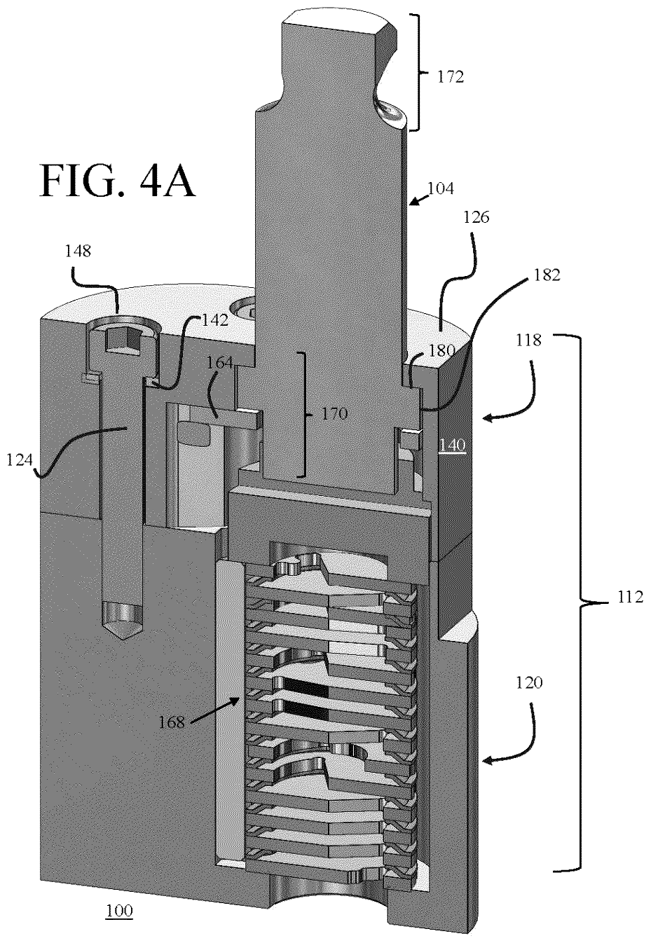

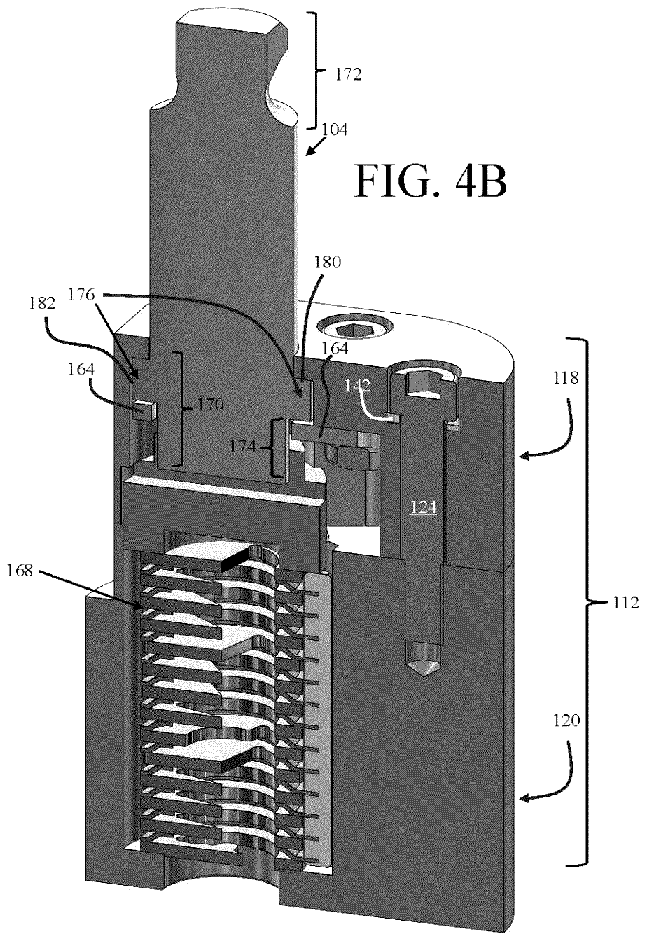

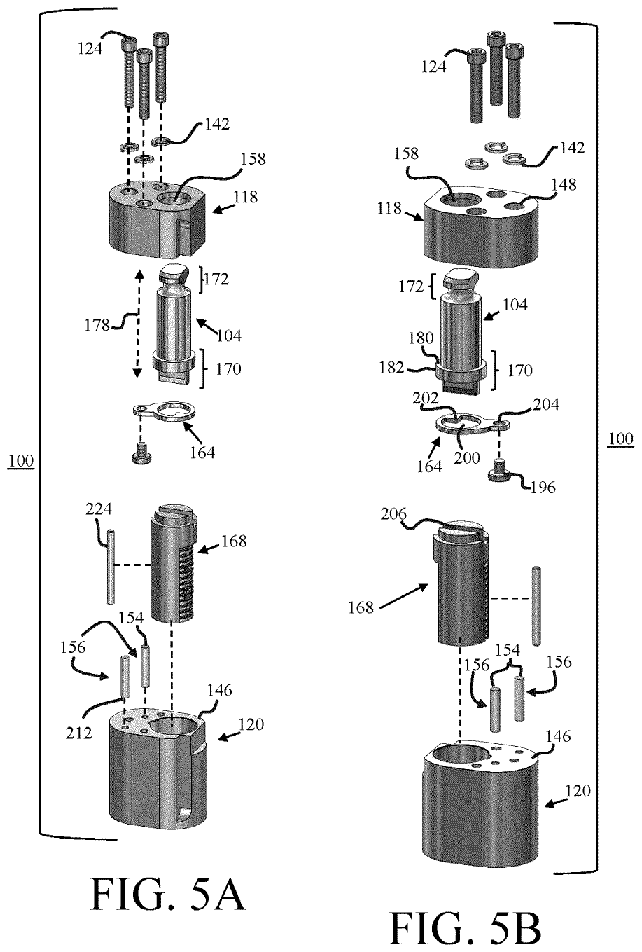

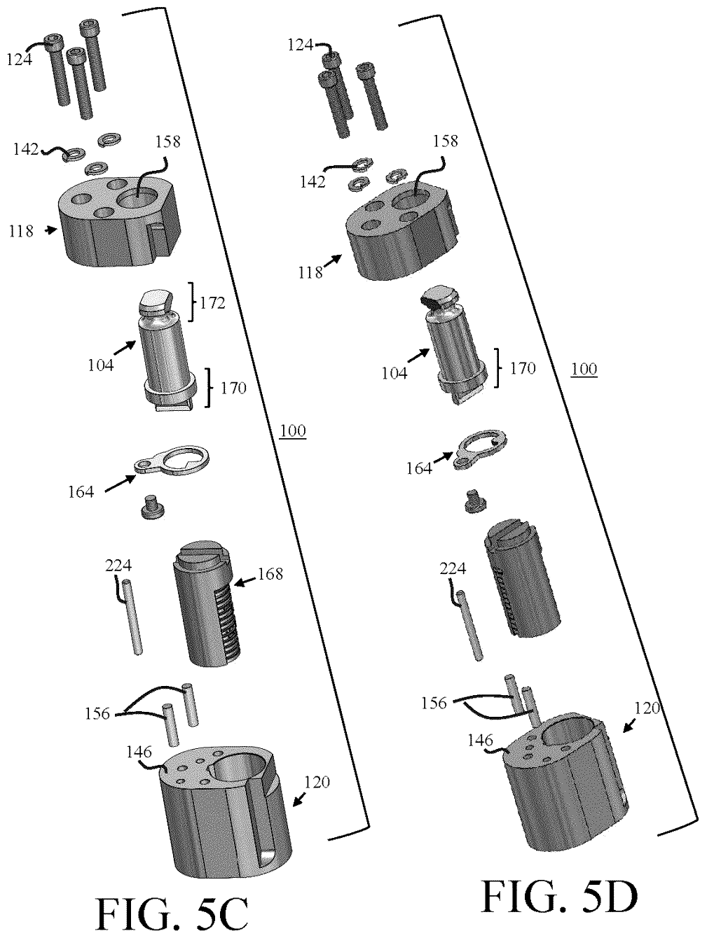

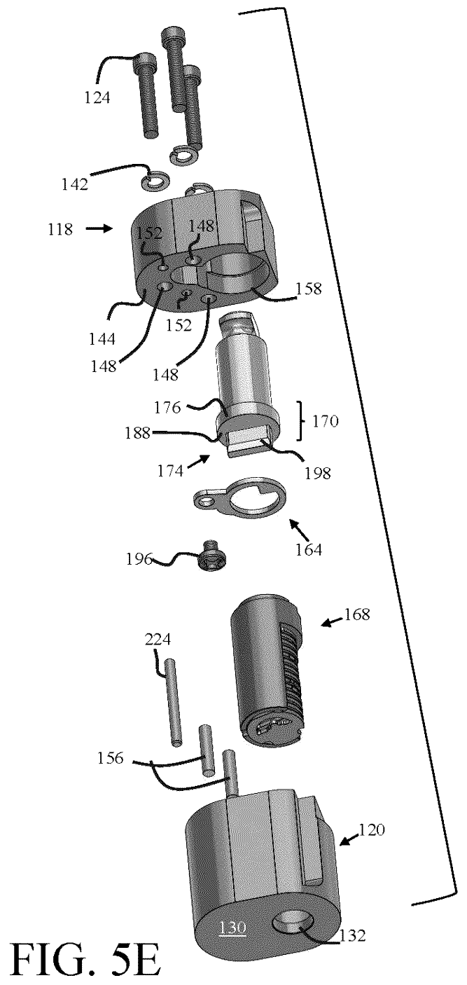

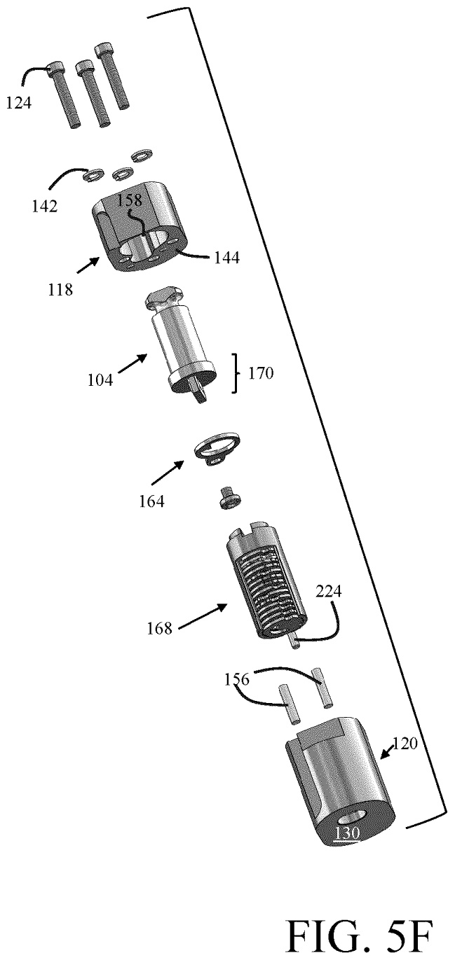

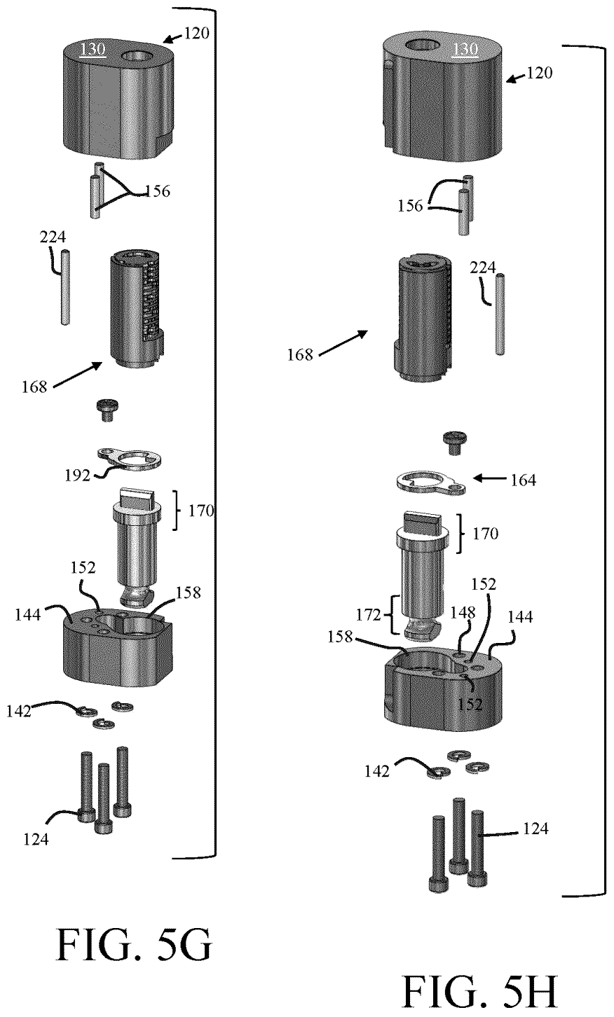

FIGS. 4A and 4B are non-limiting, exemplary cross-sectional view illustrations of the universal lock cylinder shown in FIGS. 1 to 3H in accordance with one or more embodiments of the present invention. FIGS. 5A to 5H are non-limiting exemplary exploded view illustrations of the various components of the universal lock cylinder shown in FIGS. 1 to 4B in accordance with one or more embodiments of the present invention.

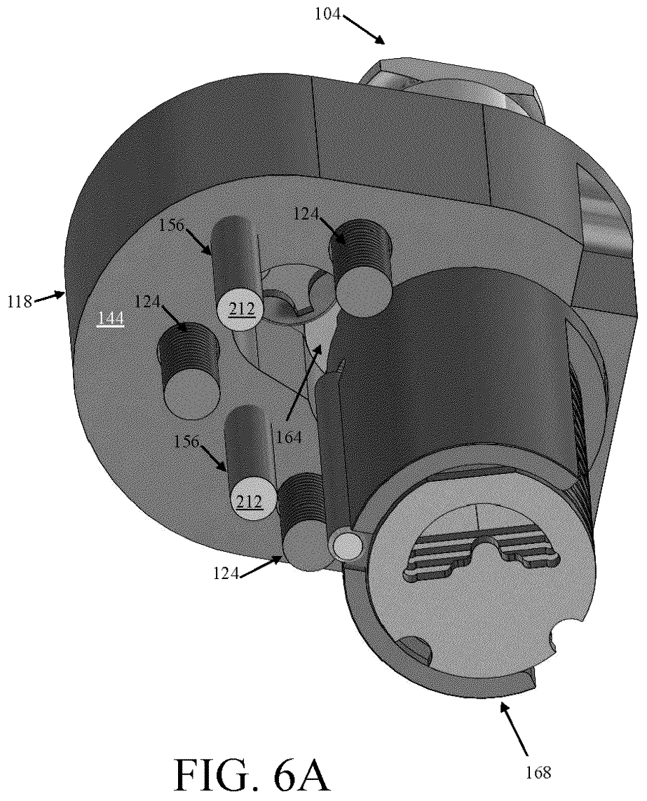

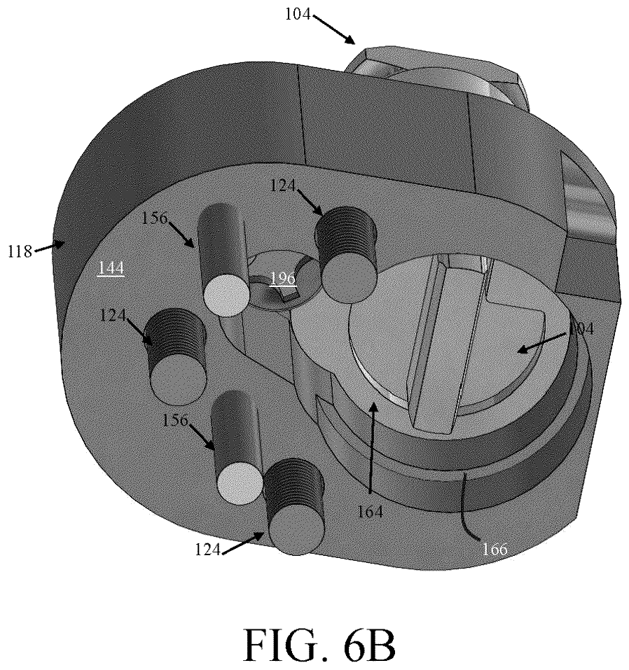

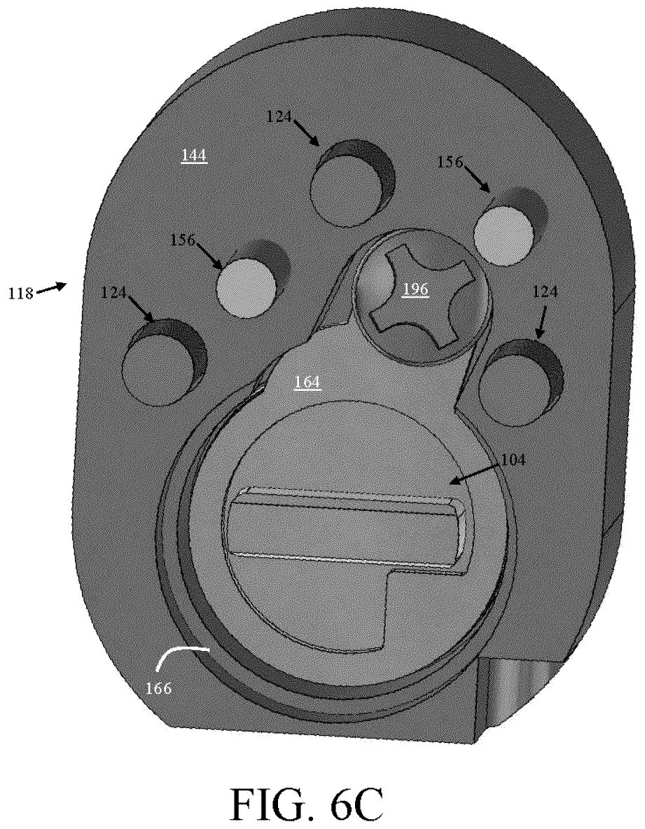

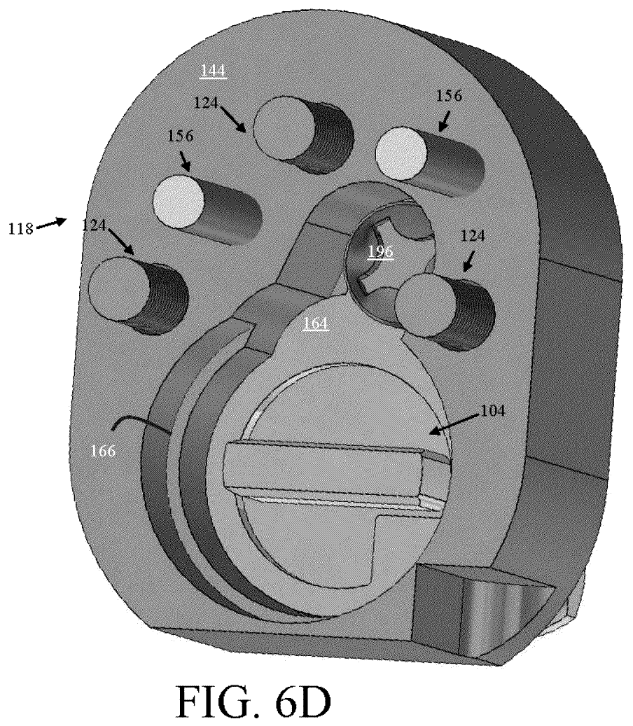

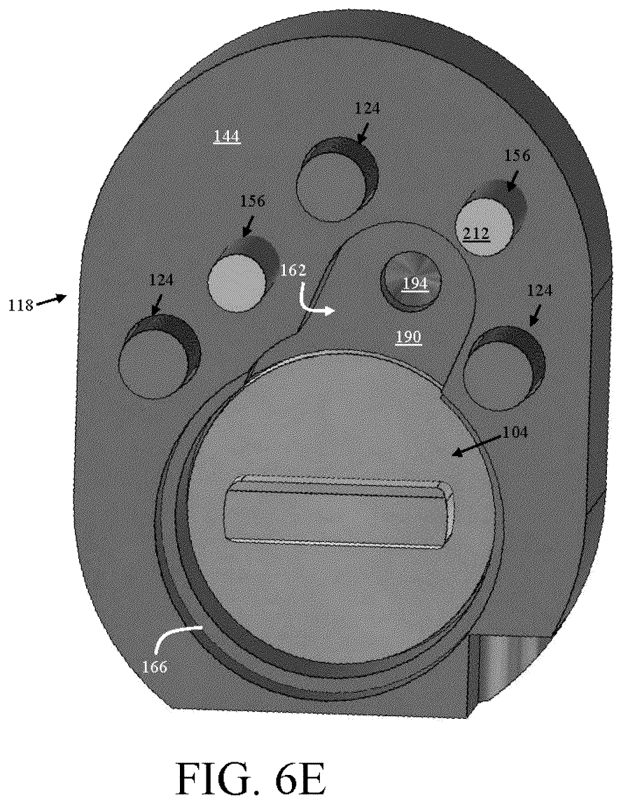

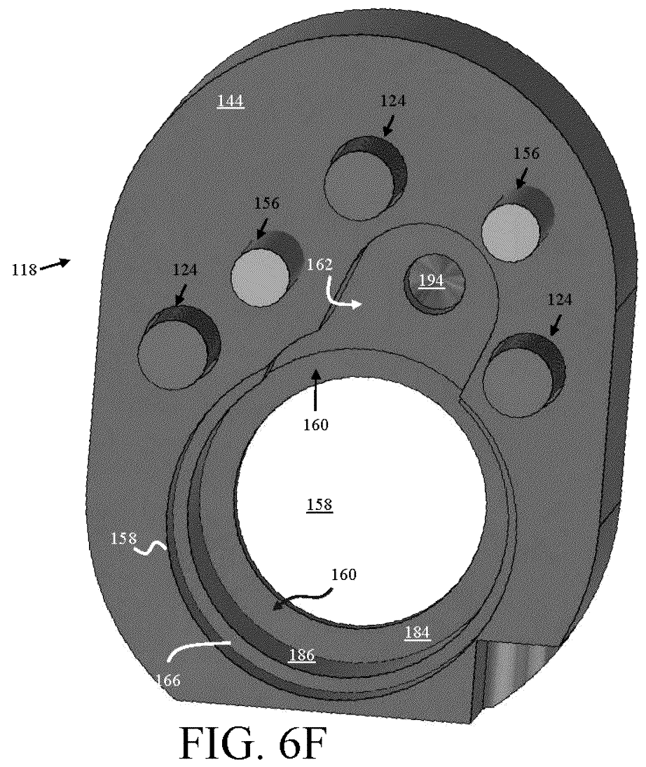

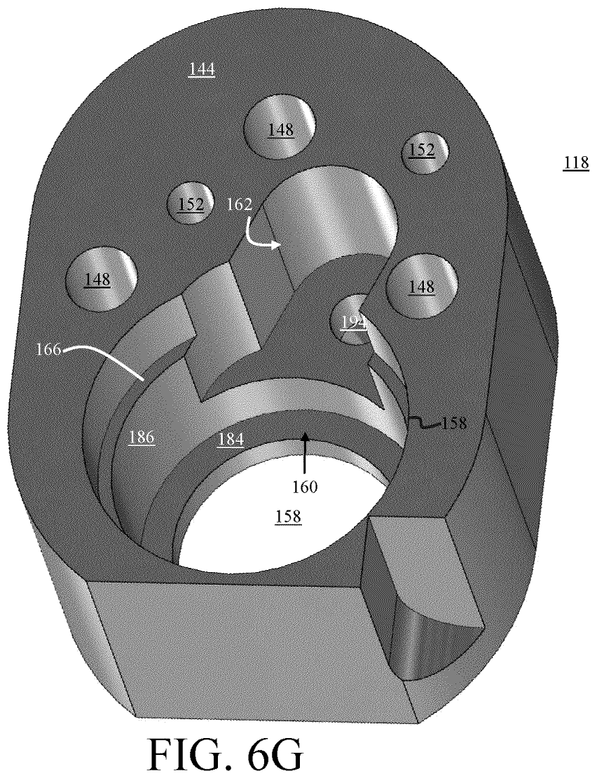

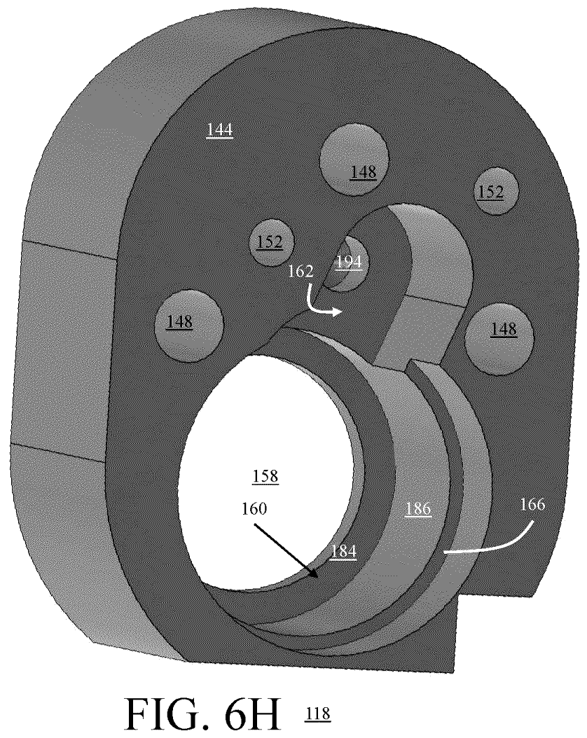

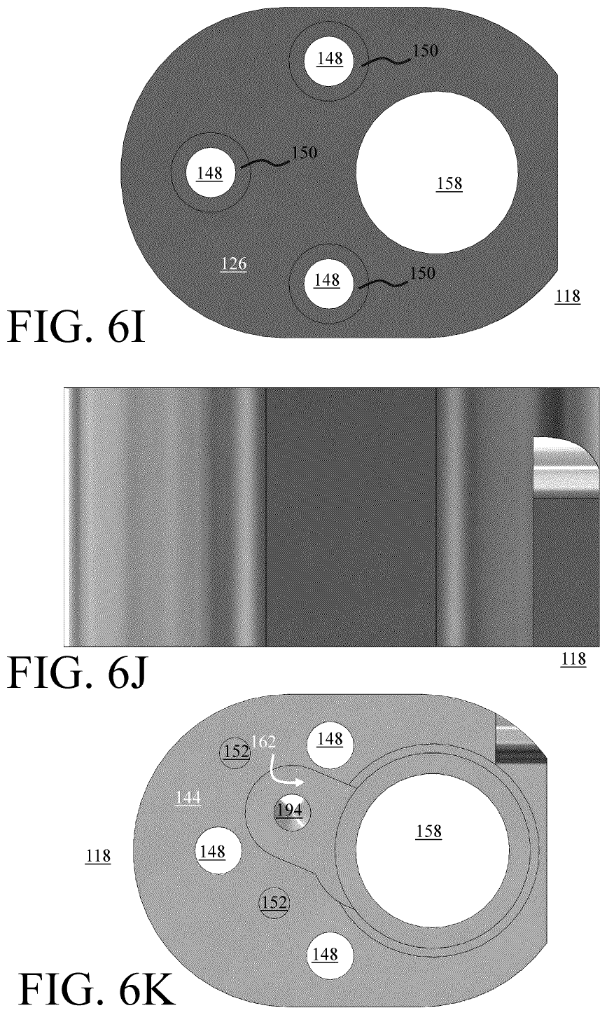

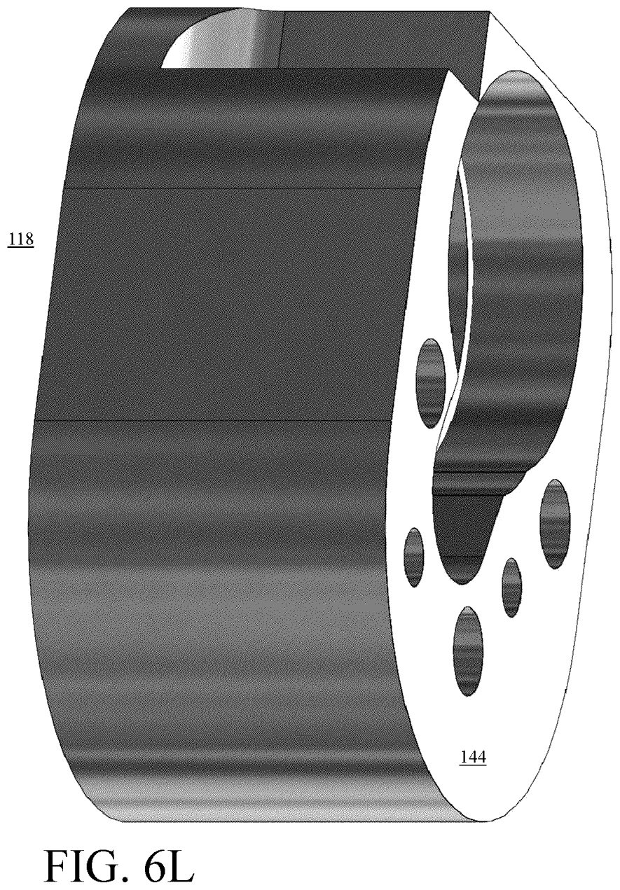

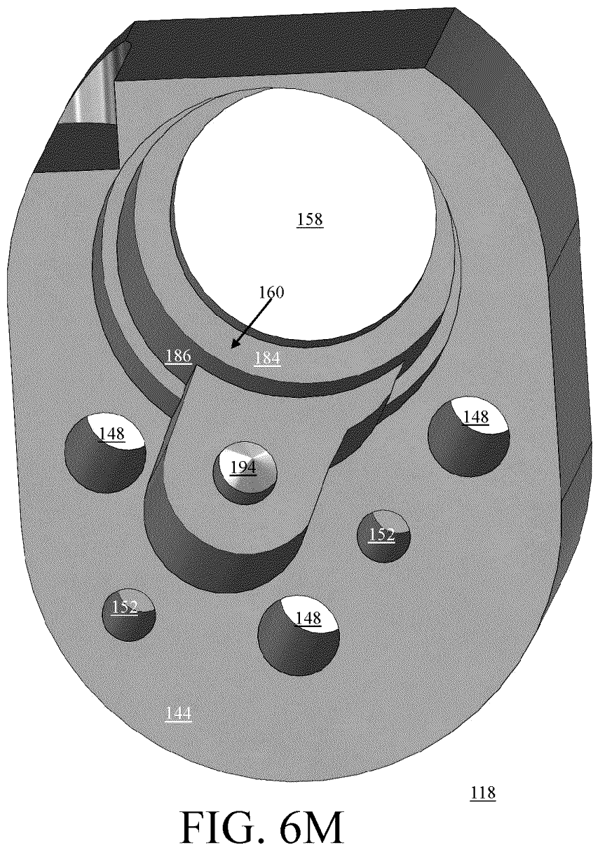

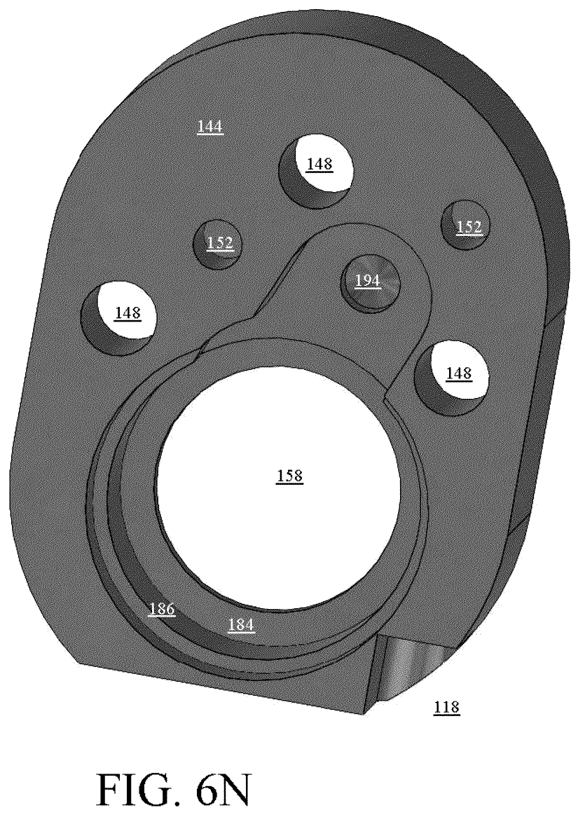

The cross-sectional and exploded views illustrate assembled and disassembled separated components that show the cooperative working relationship, orientation, positioning, and exemplary manner of assembly of the various components of universal lock cylinder 100 in accordance with one or more embodiments of the present invention, with each component detailed below. FIGS. 6A and 6N are non-limiting, exemplary illustrations of the various views of the first piece of the universal lock cylinder shown in FIGS. 1 to 5H in accordance with one or more embodiments of the present invention. FIGS. 6A to 6F progressively remove away the various components of the universal lock cylinder module to clearly illustrate their housed position within the first piece of the housing.

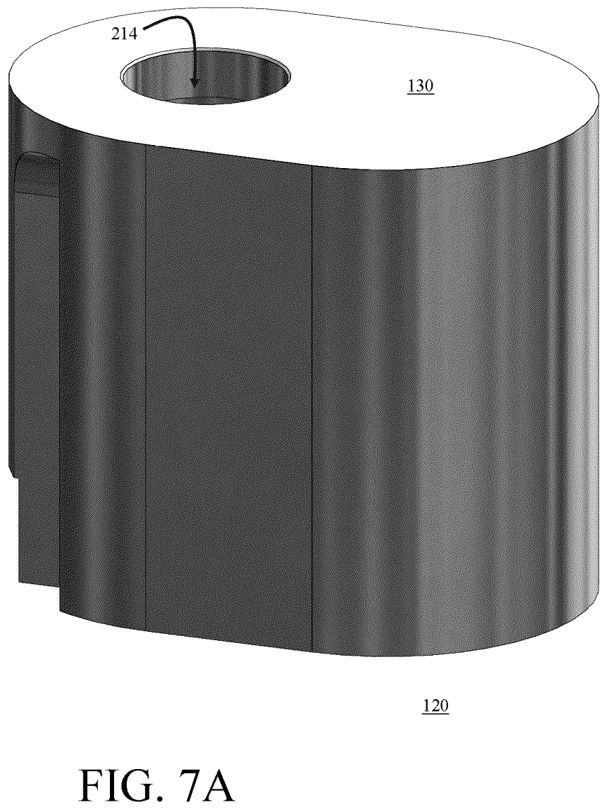

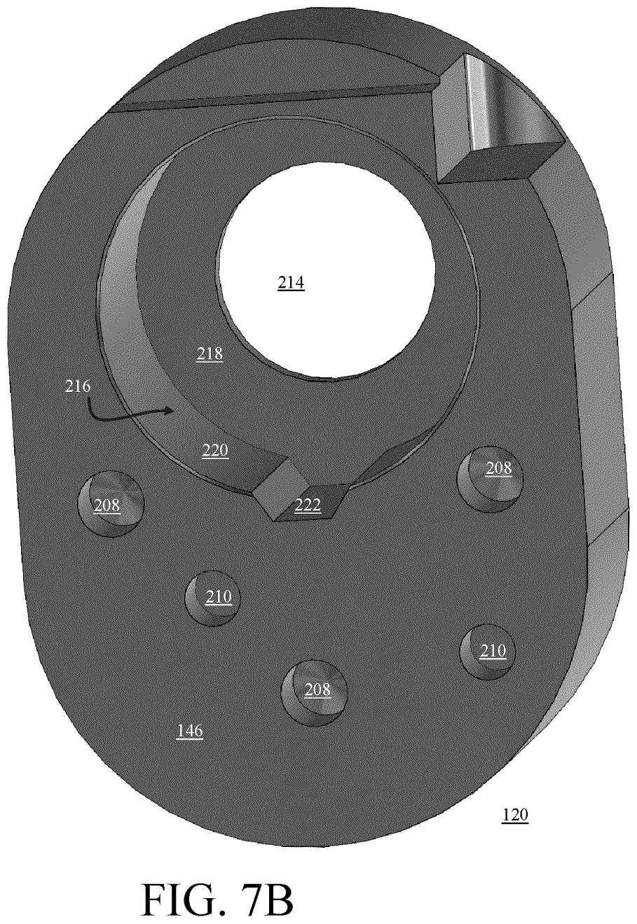

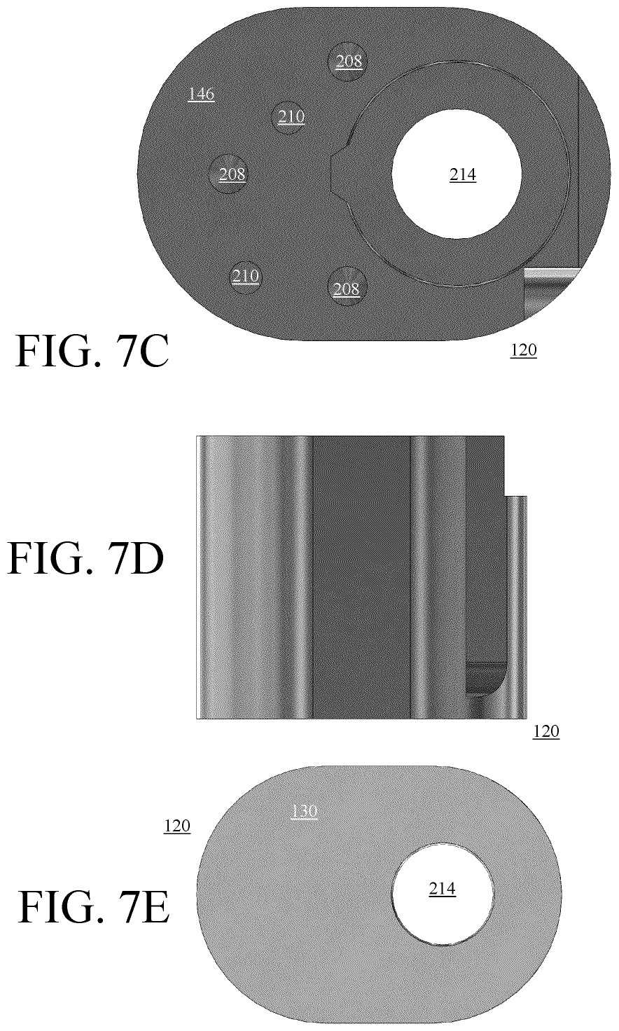

As illustrated in FIGS. 3A to 6N, housing 112 is comprised of a first piece 118 (FIGS. 6A to 6N) and a second piece 120 (FIGS. 7A to 7E) that are fixedly connected by a set of fasteners 124 using lock washers 142.

First piece 118 of housing 112 may be comprised of a first piece engagement side 144 that engages a second piece engagement side 146 (FIGS. 7B and 7C) of second piece 120 (FIGS. 7A to 7E).

First piece engagement side 144 of first piece 118 may further be comprised of at least one through-hole constituting fastener opening 148 for a fastener 124 that secures first and second pieces 118 and 120 together to form housing 112.

Fastener opening 148 may have a counterbored opening 150 to allow fastener 124 to be slightly recessed within a top outer surface 126 of first piece 118 of housing 112.

First piece engagement side 144 of first piece 118 may further be comprised of at least one blind-hole 152 (alignment openings) for receiving a first distal ends 154 of a set of alignment plugs 156 used to align first and second pieces 118 and 120 for connection.

First piece engagement side 144 of first piece 118 may further be comprised of a shackle opening 158 through which the integral shackle 104 of universal lock cylinder 100 extends.

A topography of first piece engagement side 144 may be defined by a plurality of offset surfaces that define raised sides, with the offset surfaces and resulting raised sides forming recessed sections for securely housing components. A first recessed section 160 is for shackle 104; a second recessed section 162 is for a stopper 164, and a third recessed section 166 is for a rotating disc detainer 168.

A securing portion 170 of shackle 104 is integrated within first piece 118 of housing 112, with a locking portion 172 of shackle 104 extending through shackle opening 158 of first piece 118 of housing 112. Locking portion 172 of shackle 104 is comprised of a well known, conventional locking configuration.

A securing distal end 174 of securing portion 170 of shackle 104 is associated with rotating disc detainer 168. Securing portion 170 includes circular flange 176 that circumferentially projects and extends transversally, perpendicular to a longitudinal axis 178 of shackle 104.

First and lateral sides 180 and 182 of circular flange 176 of securing portion 170 are received within a correspondingly configured first recessed section 160, thus preventing shackle 104 from sliding out of housing 112.

First side 180 of circular flange 176 is confined within first piece 118 by an annular flange 184 of first recessed section 160 while lateral side 182 of securing flange 176 is confined by an annular wall 186 of first recessed section 160.

A second side 188 of circular flange 176 of securing portion 170, opposite first side 180, is stopped from moving by stopper 164, thus preventing shackle 104 from moving from first piece 118 of housing 112 and into second piece 120.

Second recessed section 162 includes stopper recessed portion 190 having a silhouette configured commensurate with a corresponding outer periphery 192 of stopper 164. Stopper recessed portion 190 further includes a blind-hole 194 for fastener 196 for securing stopper 162.

Securing distal end 174 of securing portion 170 of shackle 104 includes an interlocking projection 198 that as detailed below, is associated with rotating disc detainer 168.

Stopper 164 includes stopper opening 200 that has a stop 202 that extends within stopper opening 200, and a securing opening 204 that secures stopper 164 to blind-hole 194 of stopper recessed portion 190 by fastener 196.

Interlocking projection 198 of securing distal end 174 of securing portion 170 of shackle 104 contacts stop 202 of stopper 164 when rotating disc detainer 168 is rotated to extreme lock or unlock positions.

Interlocking projection 198 of securing distal end 174 of securing portion 170 of shackle 104 is inserted through stopper opening 200 of stopper 164, and engaged with an engagement recessed portion 206 of rotating disc detainer 168.

FIGS. 7A to 7E are non-limiting, exemplary illustrations of the various views of the second piece of the universal lock cylinder shown in FIGS. 1 to 6N in accordance with one or more embodiments of the present invention.

Second piece engagement side 146 of second piece 120 may further be comprised of at least one threaded blind-hole constituting a fastener opening 208 for fastener 124 that secures first and second pieces 118 and 120 together to form housing 112.

Second piece engagement side 146 of second piece 120 may further be comprised of at least one blind-hole 210 (alignment opening) for receiving a second distal ends 212 of a set of alignment plugs 156 used to align first and second pieces 118 and 120 for connection.

Second piece engagement side 146 of second piece 120 may further be comprised of a key-opening 214 through which key 108 of universal lock cylinder 100 may be inserted into plug 168.

Key-opening 214 of housing 112 is defined by a recessed annular section 216 having an annular flange 218 and wall 220, with a section 222 of the wall 220 recessed to accommodate a locking bar 224 of rotating disc detainer 168.

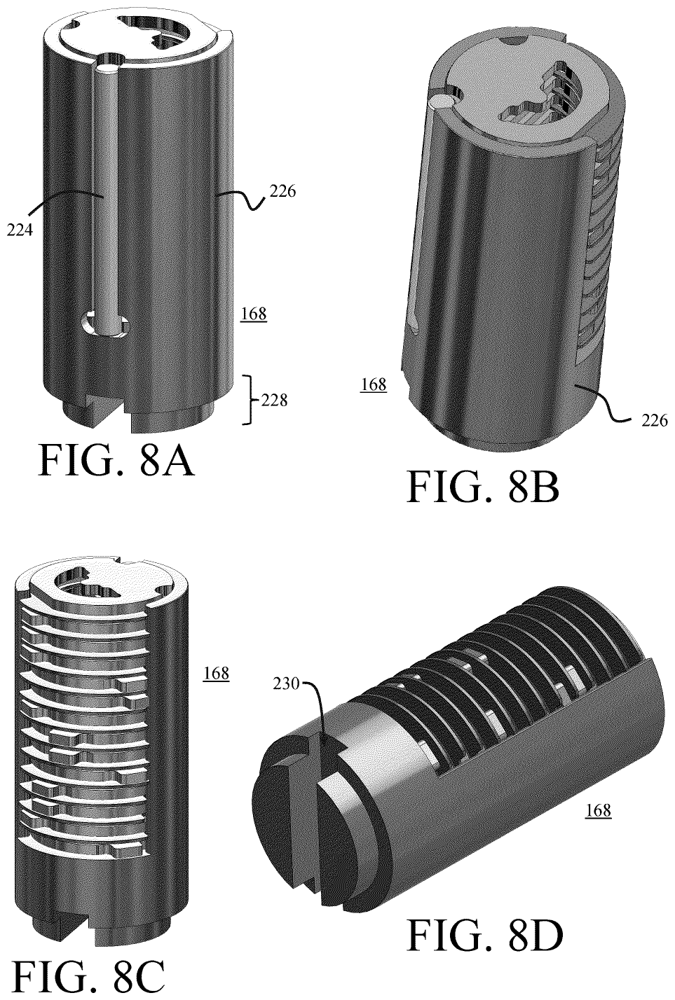

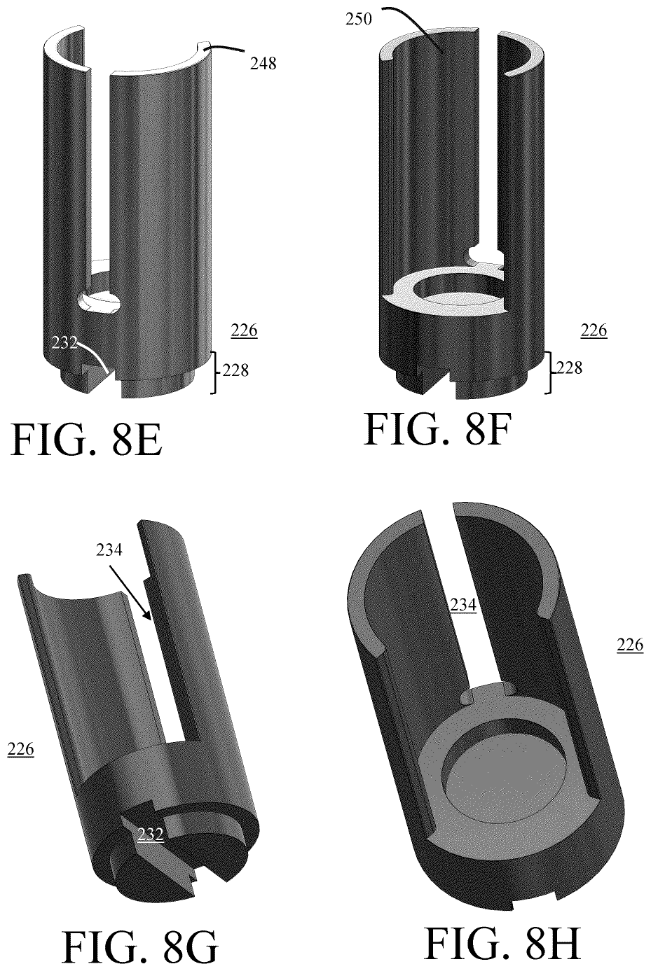

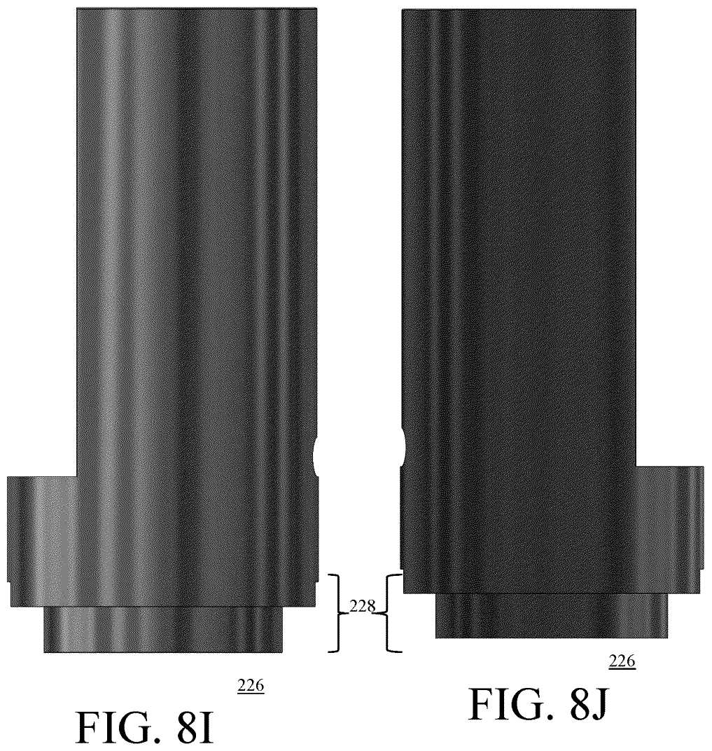

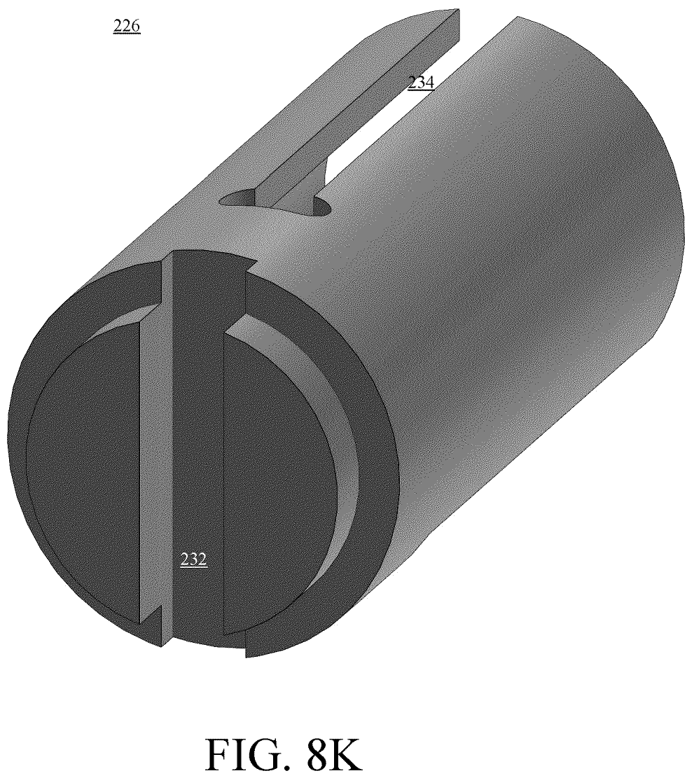

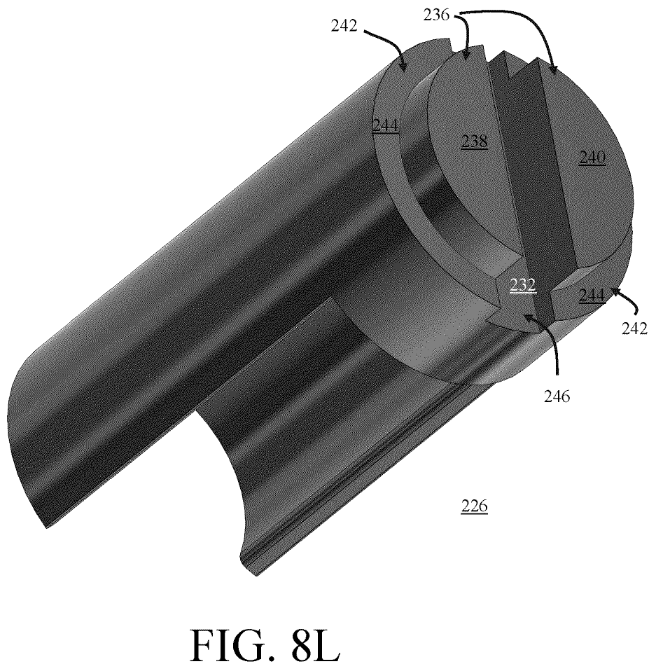

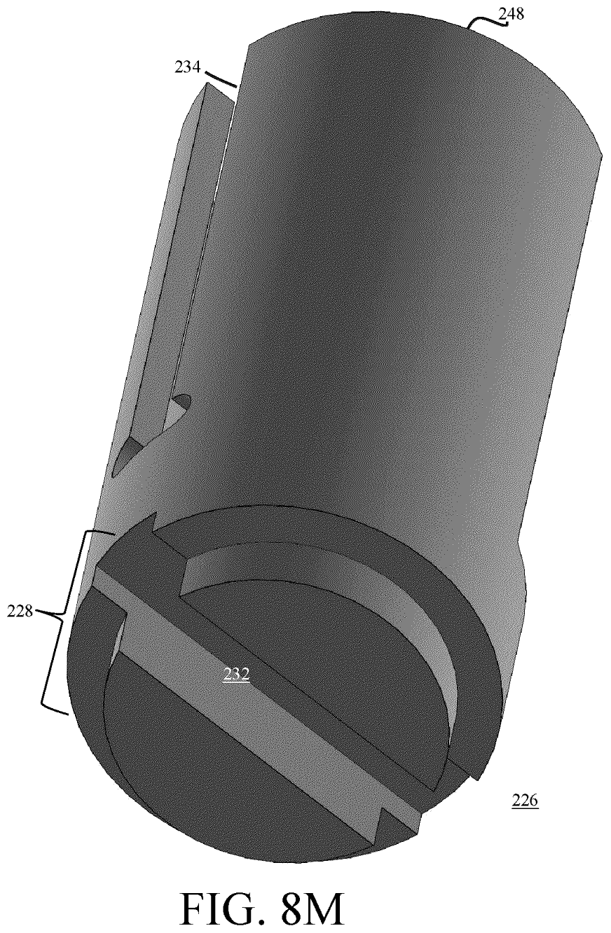

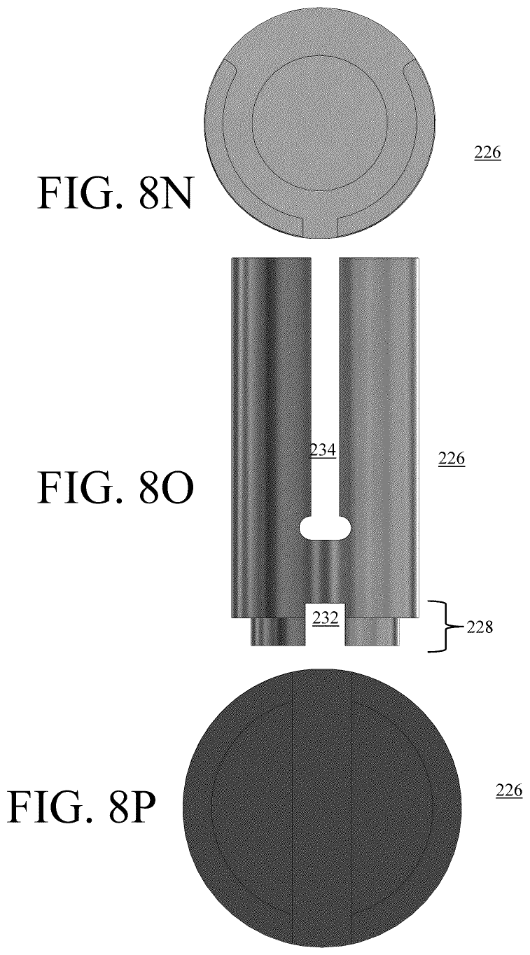

FIGS. 8A to 8D are non-limiting, exemplary illustrations of the various views of rotating disc detainer and FIGS. 8E to 8P are non-limiting, exemplary illustrations of the various views of a plug of the rotating disc-detainer of the universal lock cylinder shown in FIGS. 1 to 7E in accordance with one or more embodiments of the present invention.

As illustrated, rotating disc detainer 168 is comprised of a plug 226 that includes an engagement portion 228 with an enclosure surface 230 having an interlocking recess (or slot) 232 that receives and interlocks with a corresponding interlocking projection 198 of securing distal end 174 of securing portion 170 of shackle 104.

Rotating disc detainer 168 is further comprised of well-known spacers, between which well known discs are housed in a well-known manner. Plug 226 further includes an elongated relief opening 234 for locking bar 224 in a conventional manner.

Engagement portion 228 of plug 226 is comprised of a first offset surface 236 defined by semi-circular discs projections 238 and 240, and a second offset surface 242 that engages annular flange 166 of first piece 118, below first offset surface 236. Second offset surface 242 defines semi-annular recess sections 244, surrounding semi-circular discs projections 238 and 240.

Interlocking recess 232 extends parallel a full length of a diameter of the enclosure surface 230, defining a third offset surface 246 which extends below the semi-annular recess section 244.

Key-insertion end 248 of plug 226 is comprised of a key insertion opening 250 that is aligned with key-opening 214 of second piece 120 of housing 112 of universal lock cylinder 100.

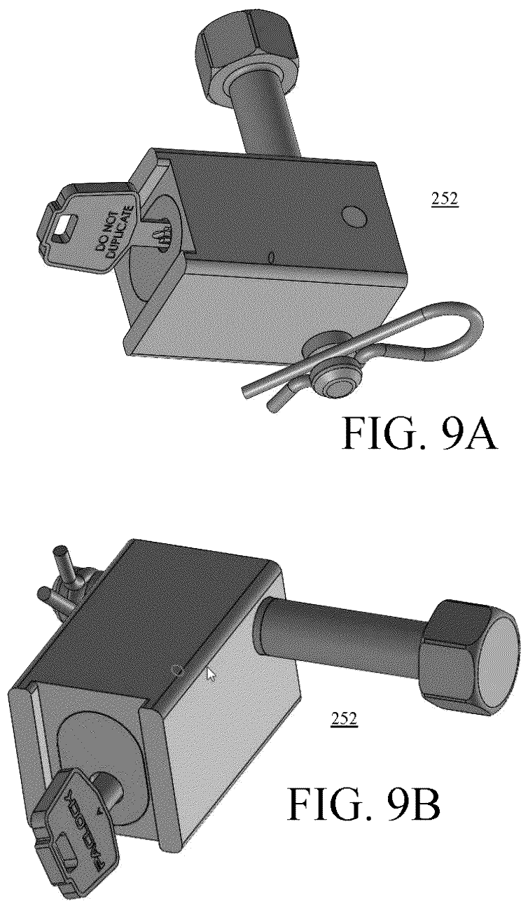

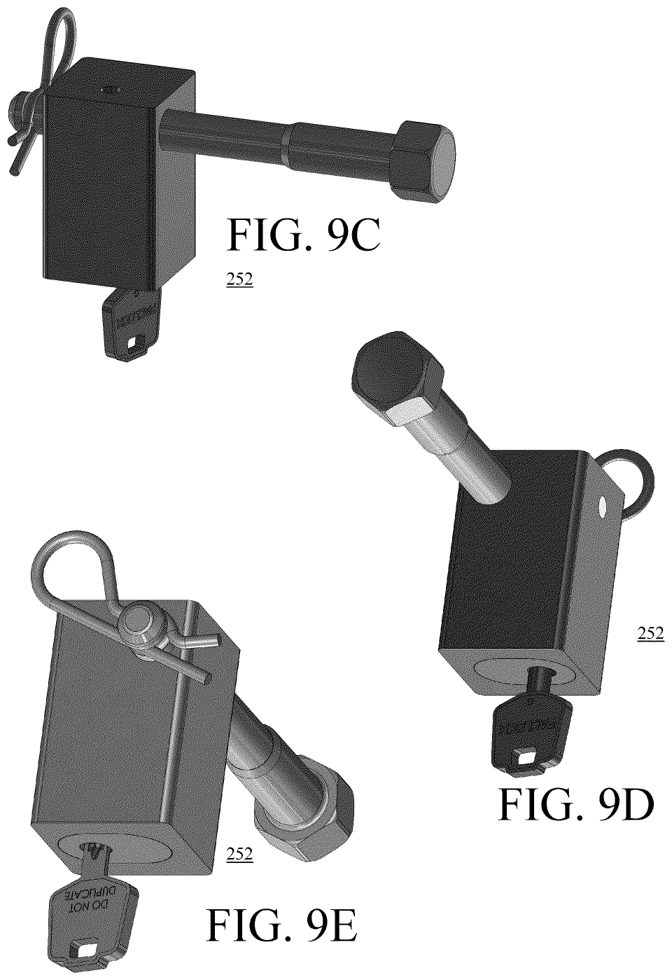

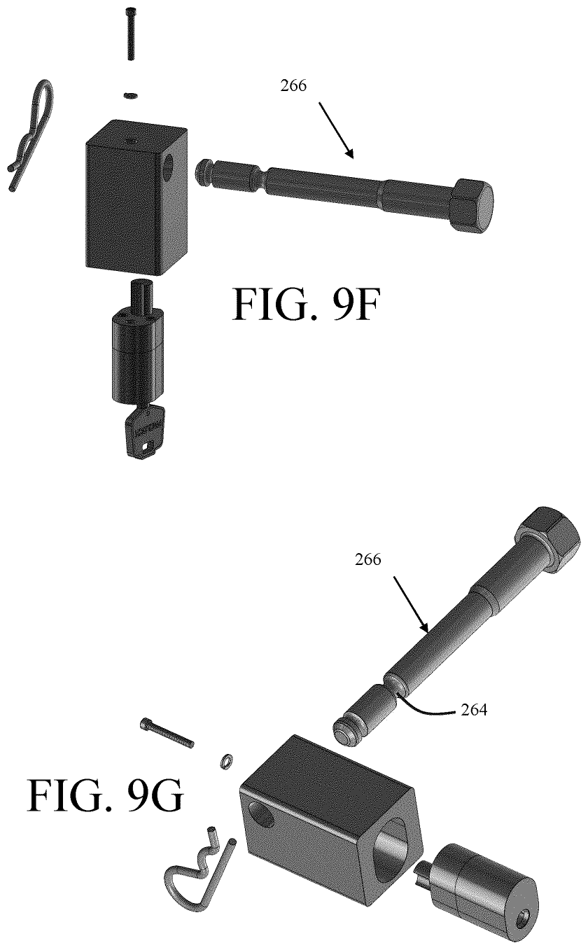

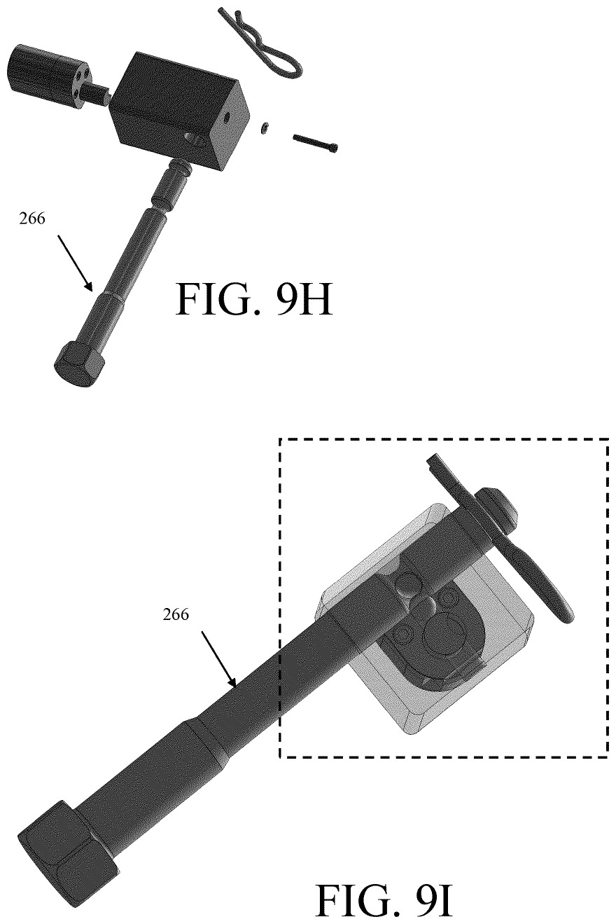

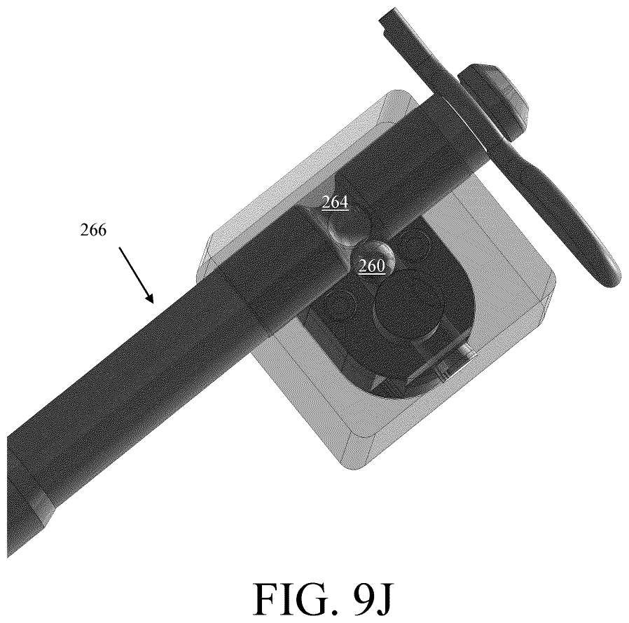

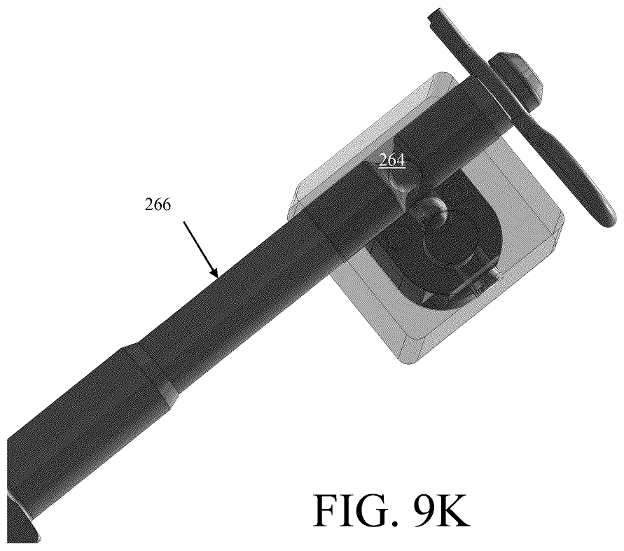

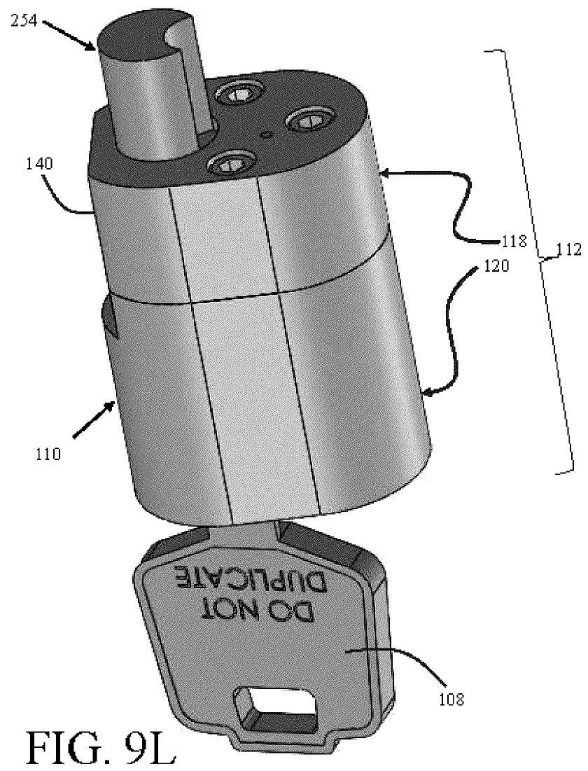

FIGS. 9A to 100 are non-limiting, exemplary illustrations of a lock device with the universal lock cylinder illustrated in FIGS. 1 to 8P, but with a different shackle in accordance with another embodiment of the present invention. Universal lock cylinder illustrated in FIGS. 9A to 100 includes similar corresponding or equivalent components, methods, interconnections, functional, operational, and or cooperative relationships as universal lock cylinder that is shown in FIGS. 1A to 8P, and described above. Therefore, for the sake of brevity, clarity, convenience, and to avoid duplication, the general description of FIGS. 9A to 100 will not repeat every corresponding or equivalent component, methods, interconnections, functional, operational, and or cooperative relationships that has already been described above in relation to universal lock cylinder that is shown in FIGS. 1A to 8P but instead, are incorporated by reference herein.

FIGS. 9A to 100 are related to a trailer hitch lock receiver 252 that uses the same universal lock cylinder 100 and housing 112 with an integral rotating disc-detainer 168 as described above, but a different shackle 254 configuration.

The actual operation of trailer hitch receiver 252 is well known but is further illustrated for clarity. In this embodiment, shackle 254 is comprised of a lock portion 256 having an elongated configuration with a semi-circular profile 258.

Semi-circular profile 258 has a general crescent shape with a recess portion for receiving a locking ball 260 (best shown in FIGS. 9J and 9K), while an opposite section 262 to the recess portion pushes locking ball 260 into a circumferential locking groove 264 of locking pin 266.

Shackle 254 is further comprised of a securing portion 268 that is identical to securing portion 170 of the above descried shackle 104 shown in FIGS. 1A to 8P and is integral with housing 112 of universal lock cylinder 100 in the same manner as described and shown in FIGS. 1A to 8P.

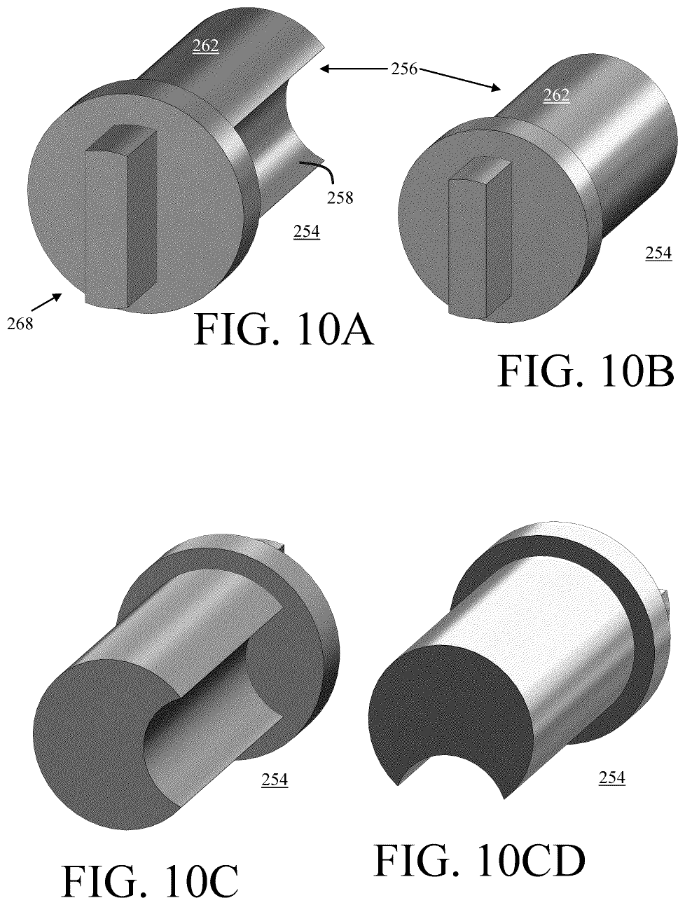

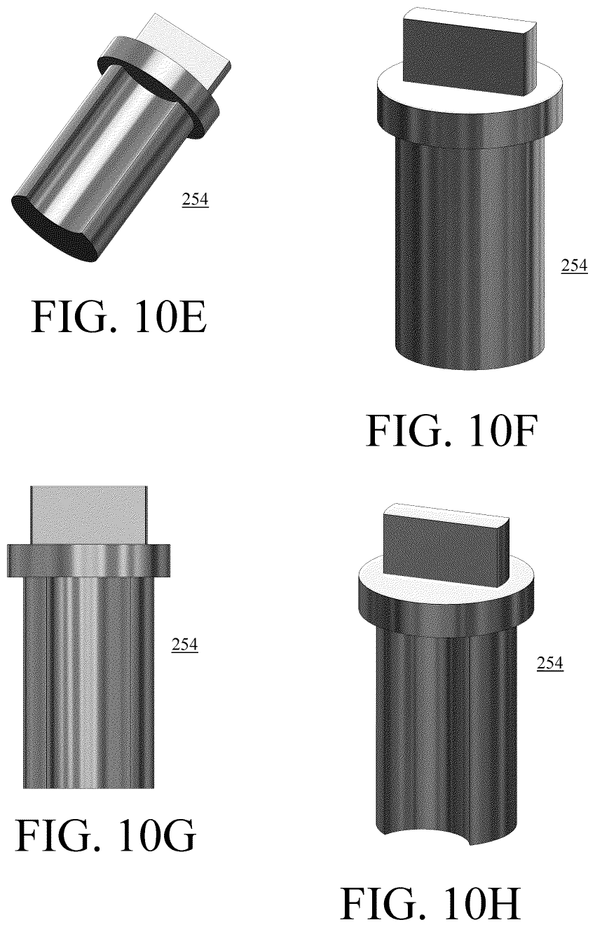

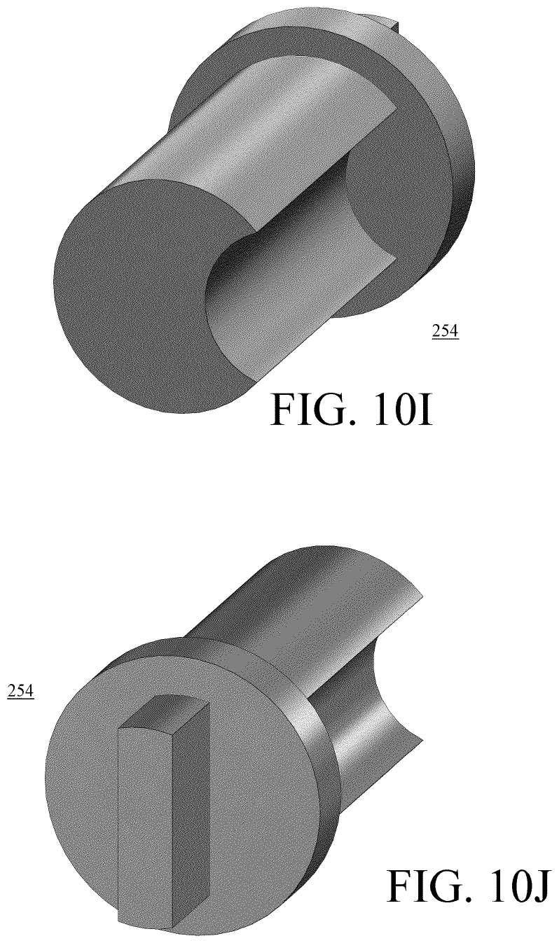

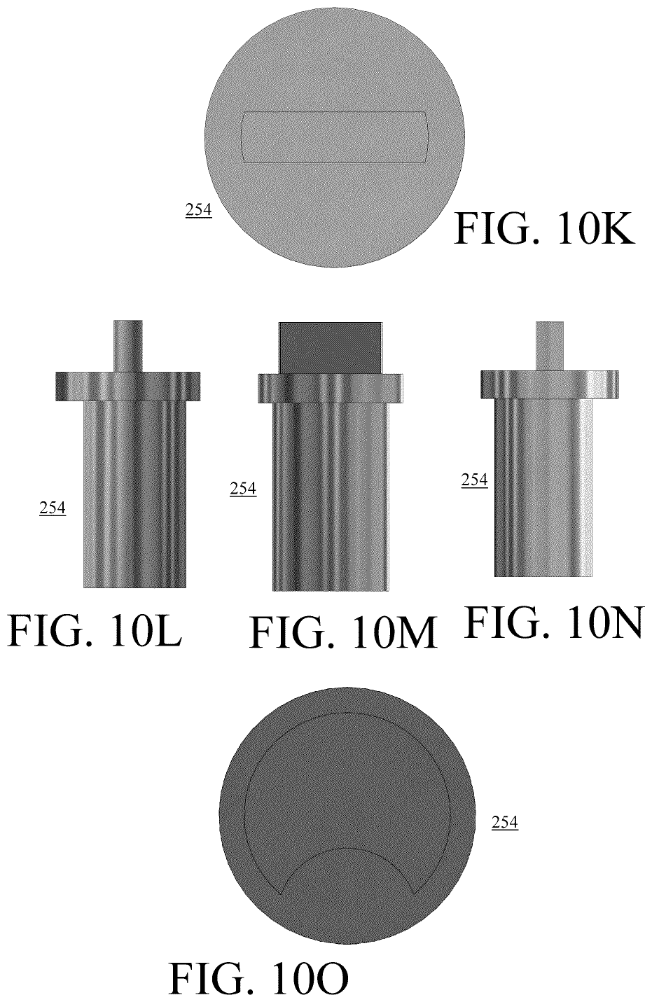

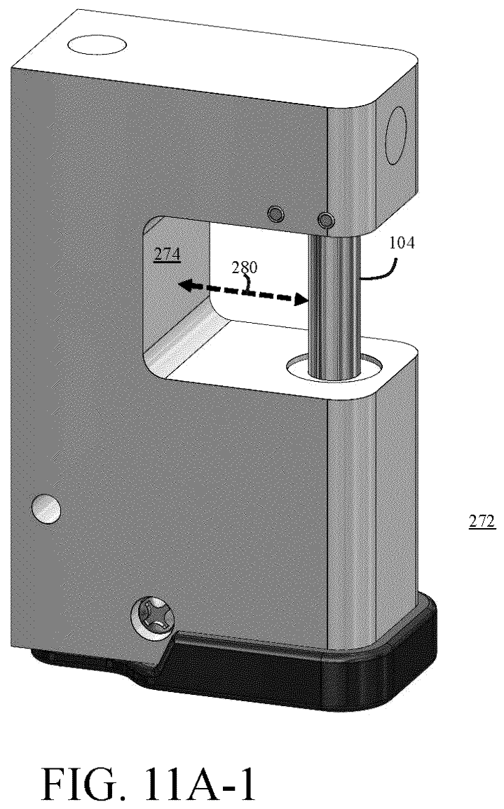

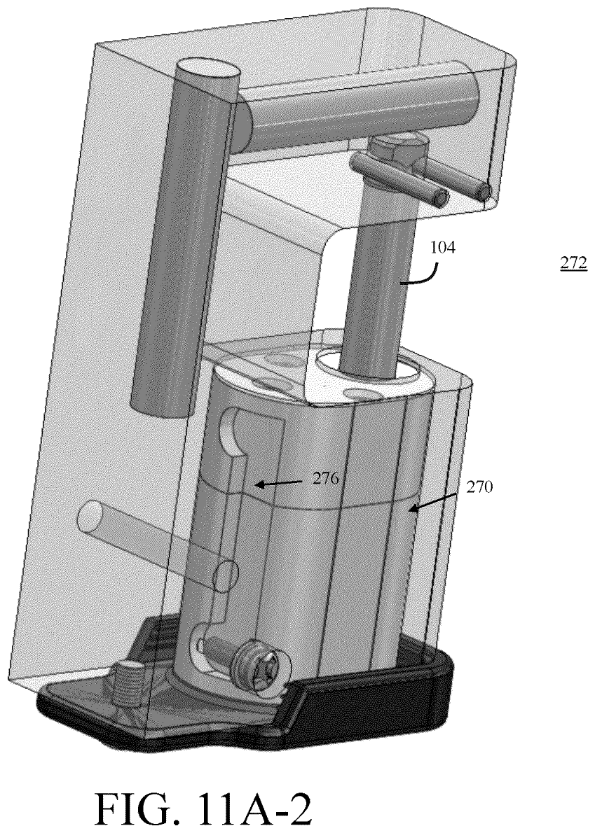

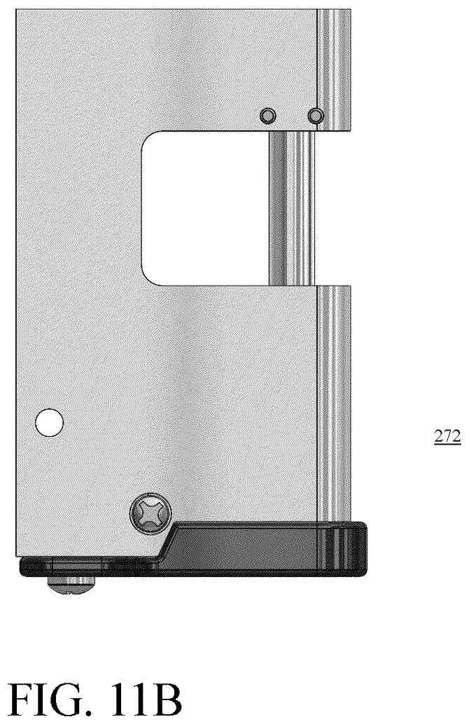

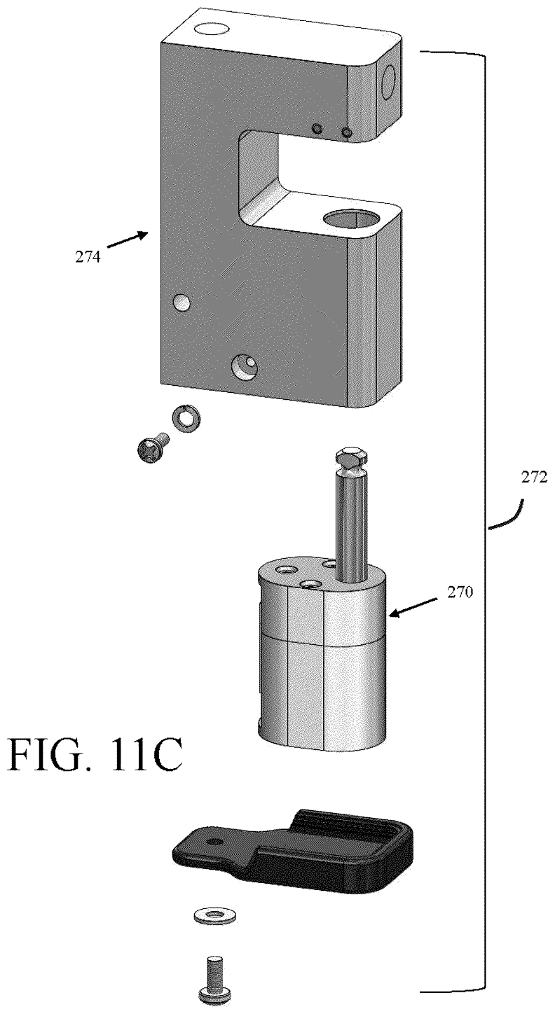

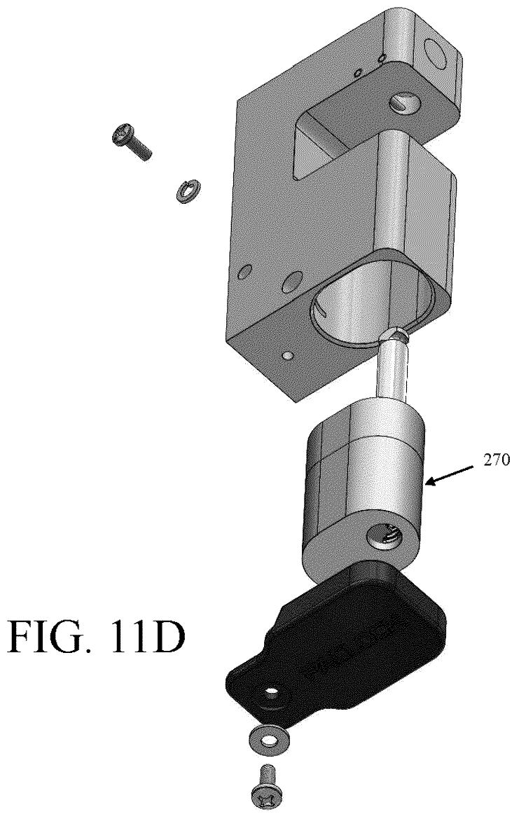

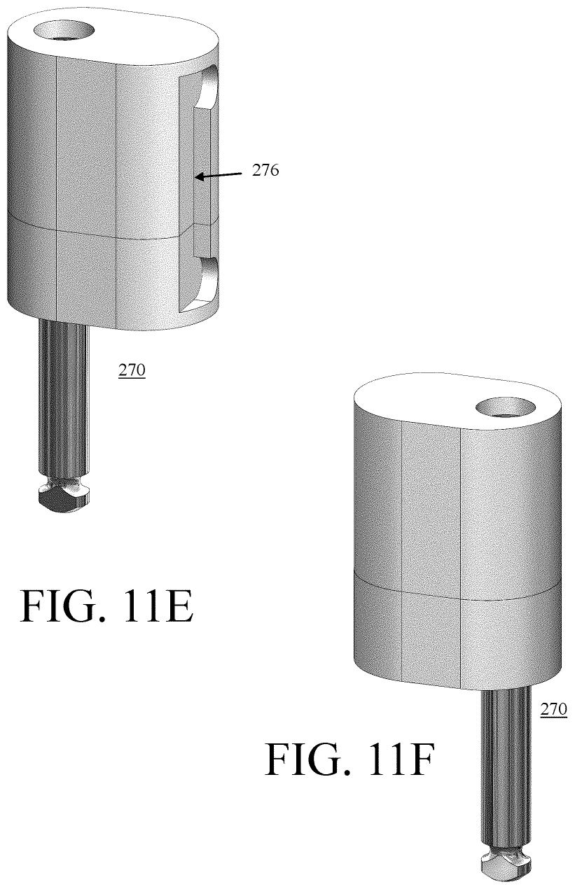

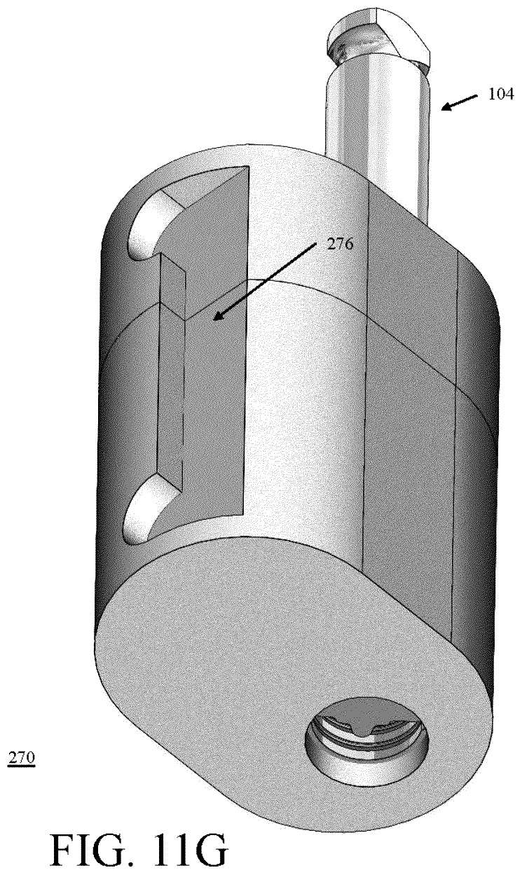

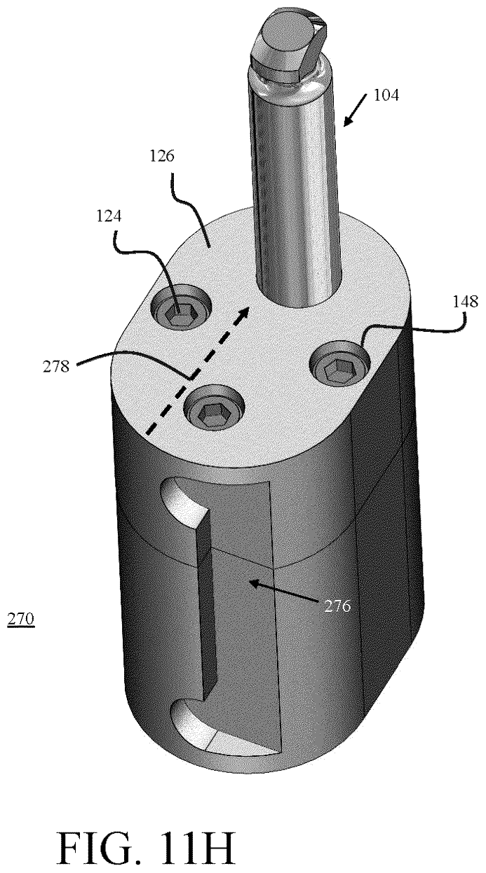

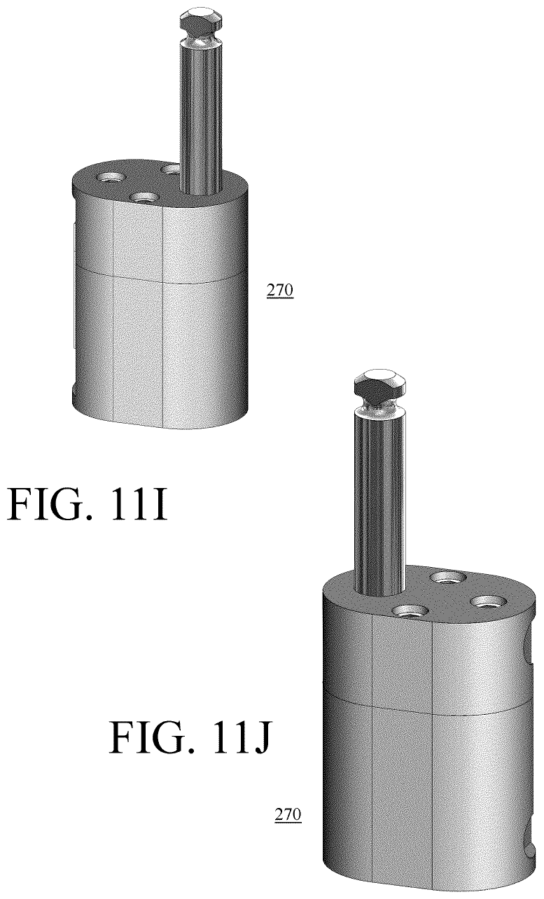

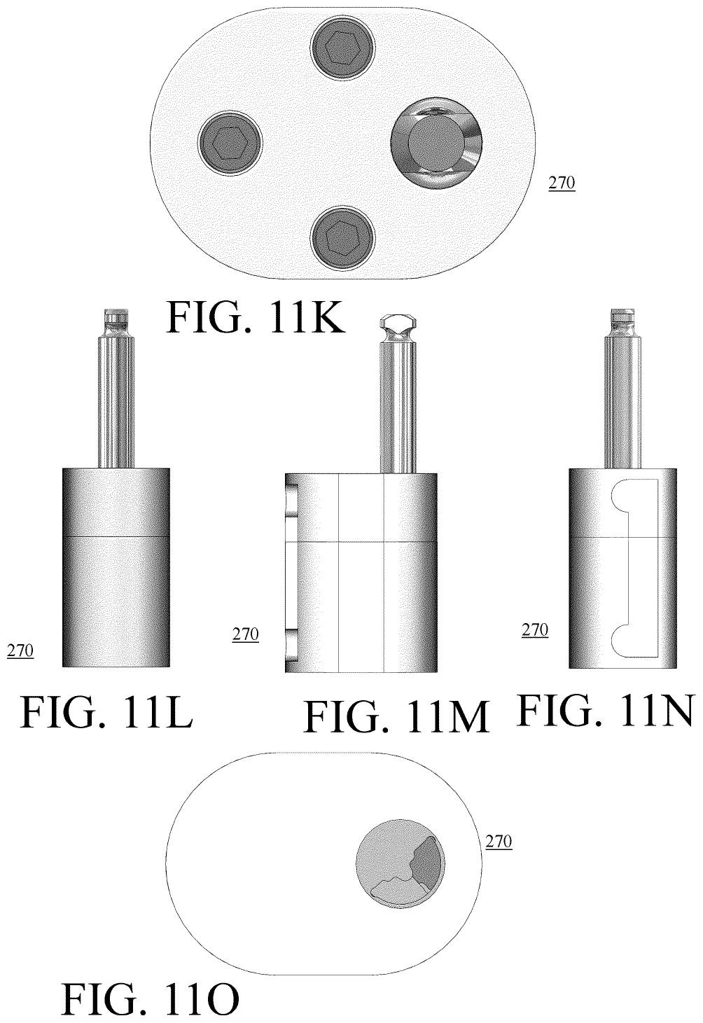

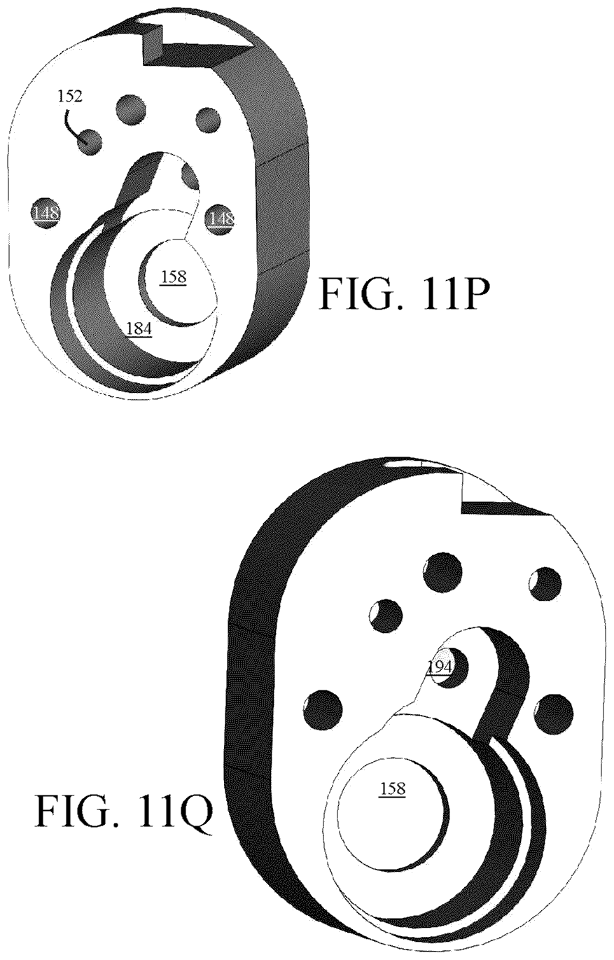

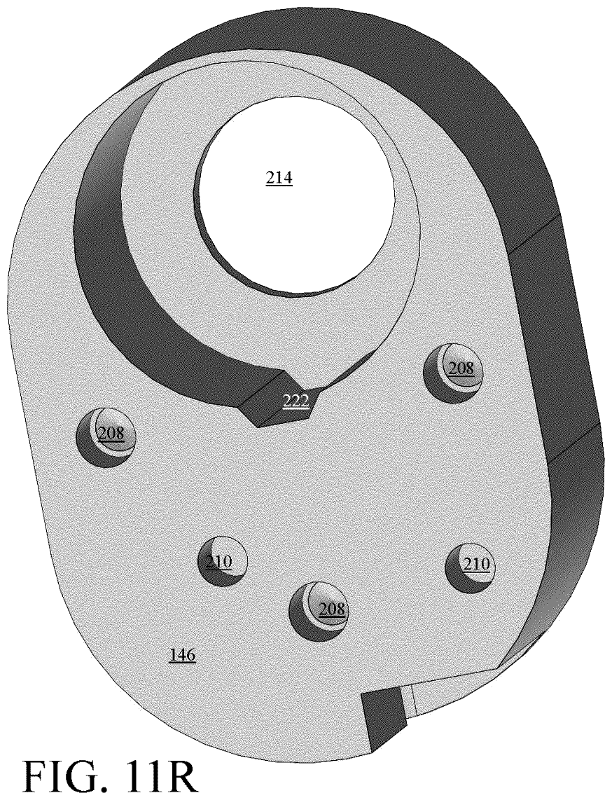

FIGS. 11A-1 to 11R are non-limiting, exemplary illustrations of a lock device that uses a universal lock cylinder in accordance with another embodiment of the present invention. Universal lock cylinder 270 illustrated in FIGS. 11A to 11R includes similar corresponding or equivalent components, methods, interconnections, functional, operational, and or cooperative relationships as universal lock cylinder 100 that is shown in FIGS. 1A to 100, and described above. Therefore, for the sake of brevity, clarity, convenience, and to avoid duplication, the general description of FIGS. 11A to 11R will not repeat every corresponding or equivalent component, methods, interconnections, functional, operational, and or cooperative relationships that has already been described above in relation to universal lock cylinder 100 that is shown in FIGS. 1A to 100 but instead, are incorporated by reference herein.

FIGS. 11A-1 to 11R are illustrations of a trailer hitch lock 272 that uses the same universal lock cylinder 100 and housing 112 with integral rotating disc-detainer 168 and shackle 104 as described above, except for minor repositioning (or shifting by a few millimeters) of various components (detailed below).

In this embodiment, interlock pin recess 276 (FIG. 11G and 11H) to retain universal lock cylinder 270 within protective lock casing 274 has a slightly different configuration, but with identical function as described above in relation to retainer recessed cavity 134 shown FIGS. 1A to 100.

In this embodiment, the position of shackle 104 is slightly shifted 278 to allow for mating with casing 274 in the lock position. Shifting 278 the position of shackle 104 would also compel shifting of the other openings such as alignment openings 152/210, fastener openings 148/208, shackle opening 158, key opening 214, etc. (shown in FIGS. 11P to 11R).

In this embodiment, shifting 278 of shackle 104 allows for an increased clearance 280 (shown by dashed arrow in FIG. 11A) between casing 274 and shackle 104 to allow for sufficient space to enable lock device 272 to lock with a trailer hitch without reducing or adding bulk to casing.

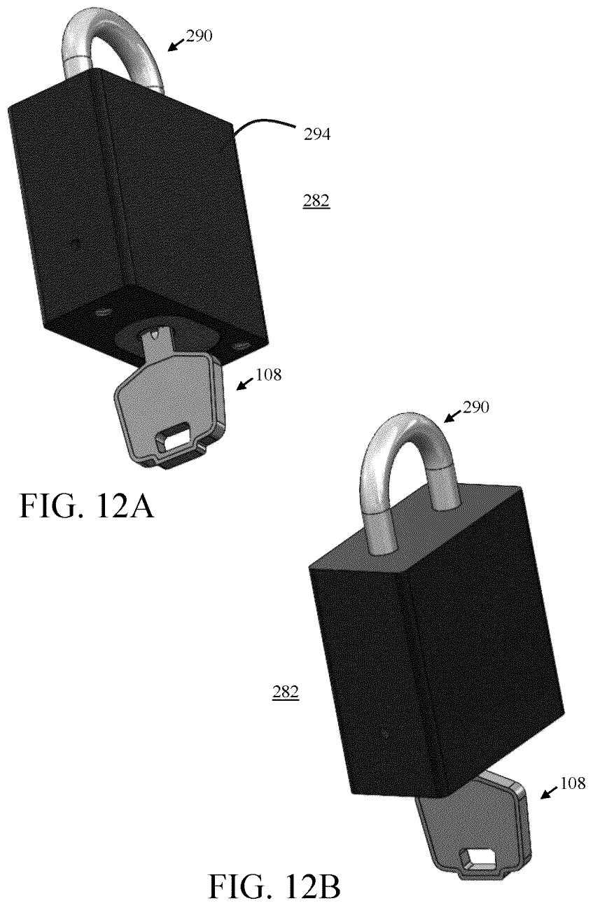

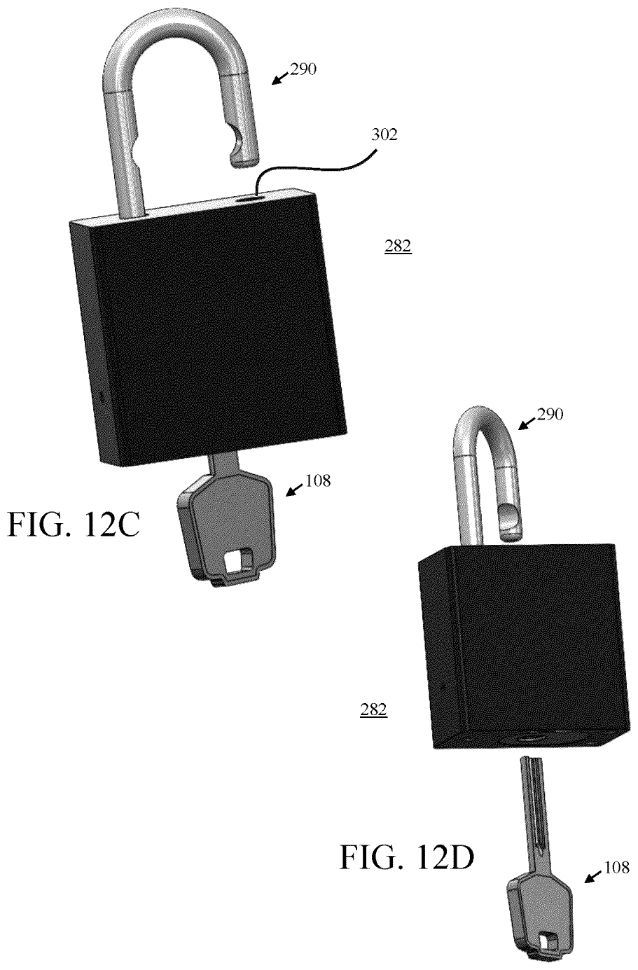

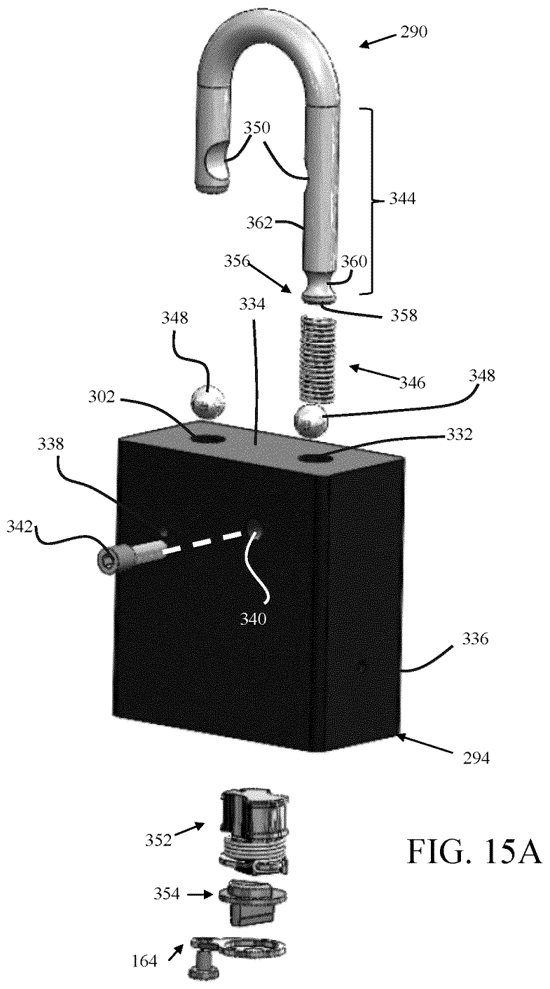

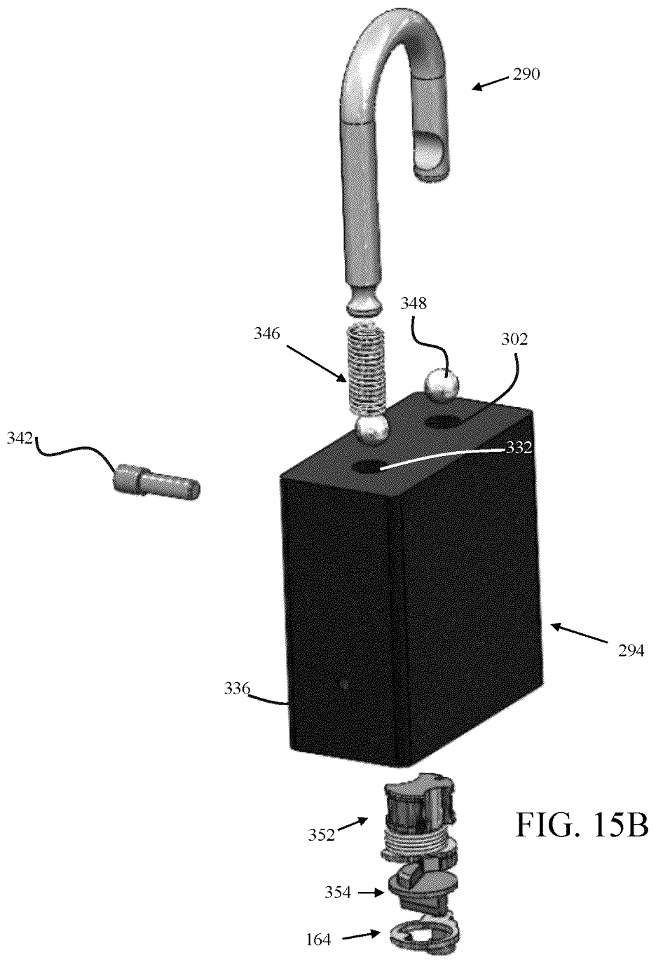

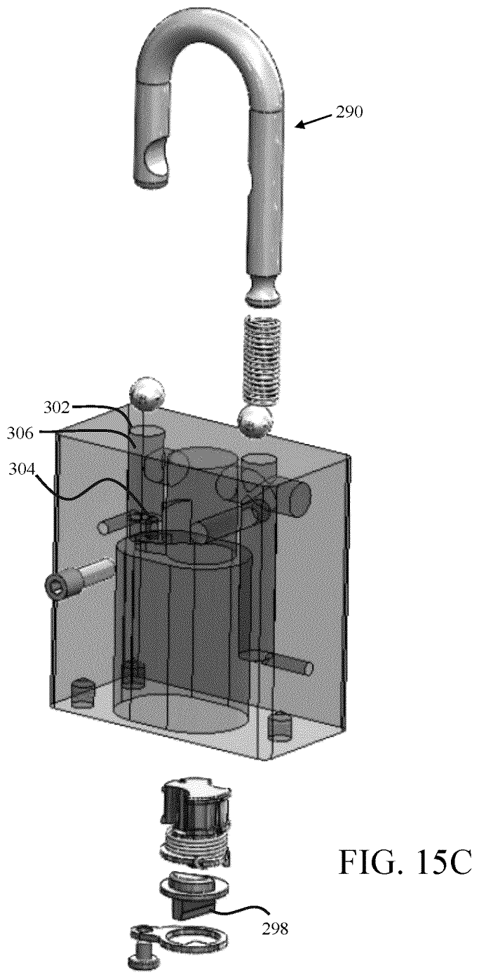

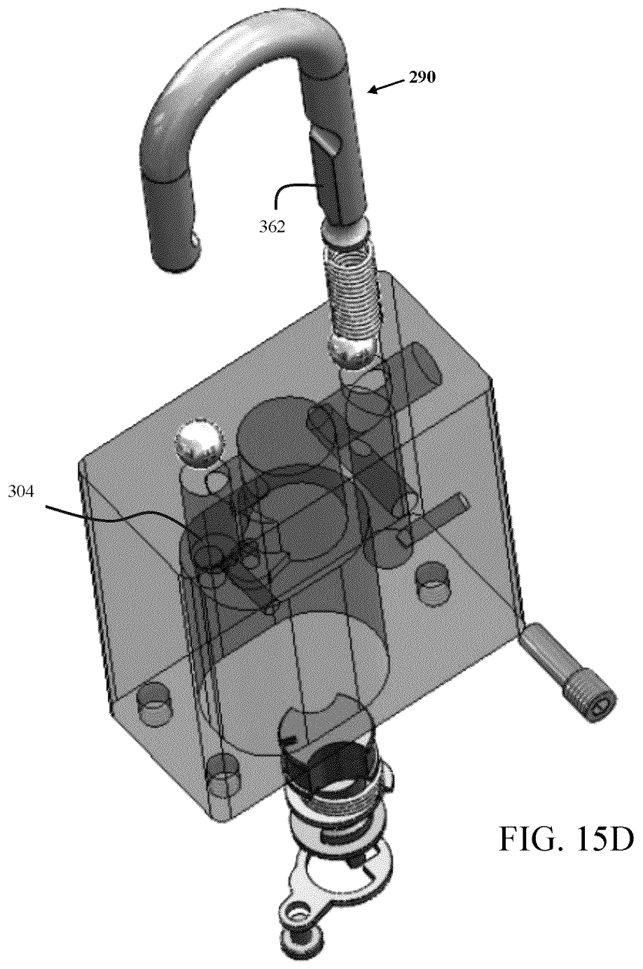

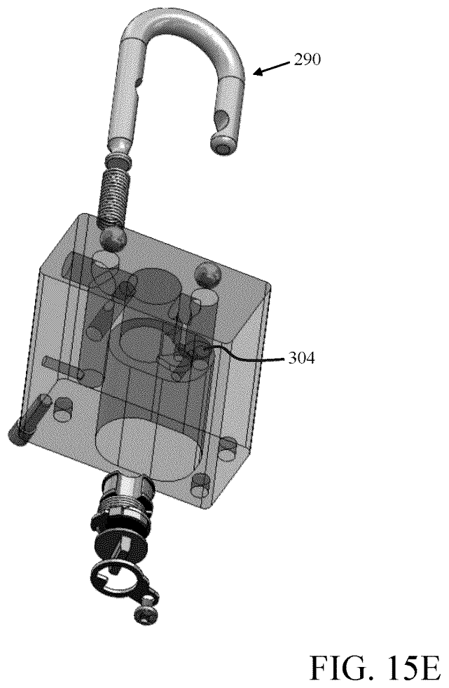

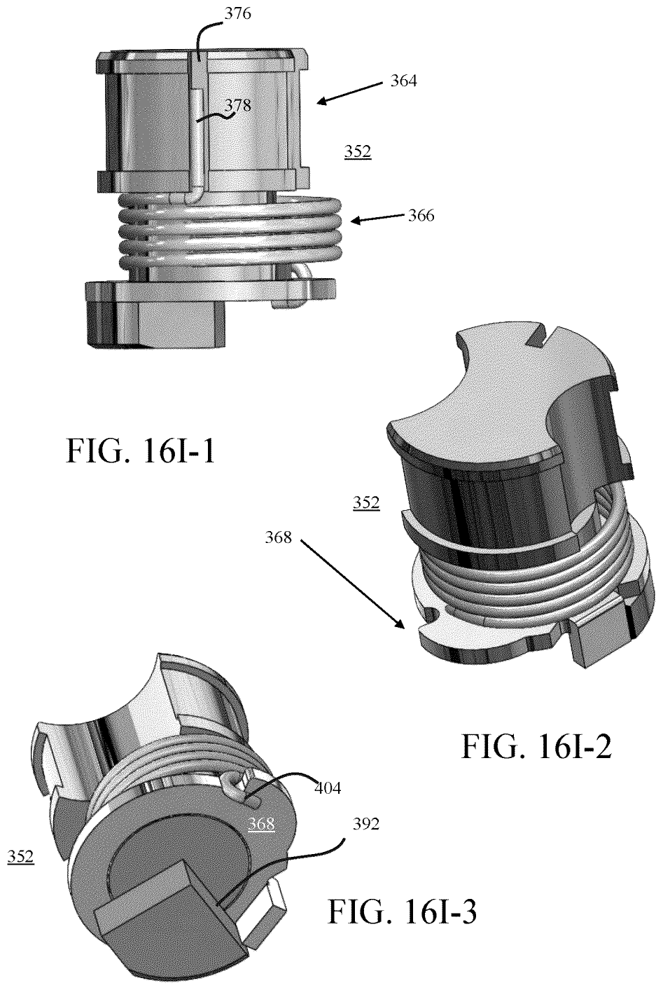

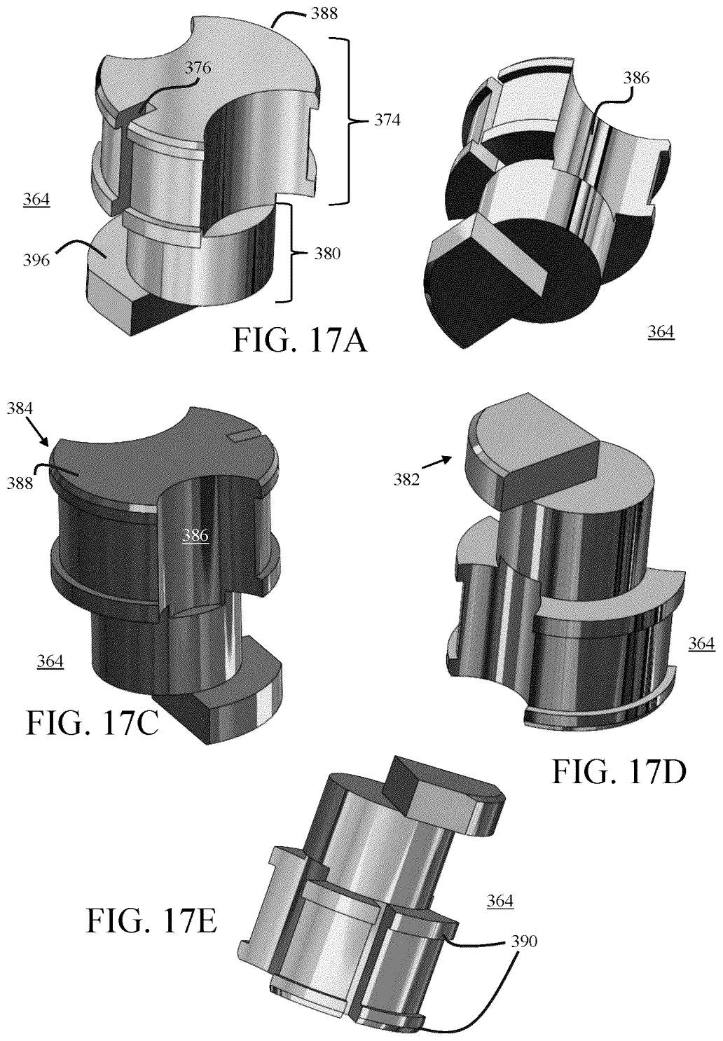

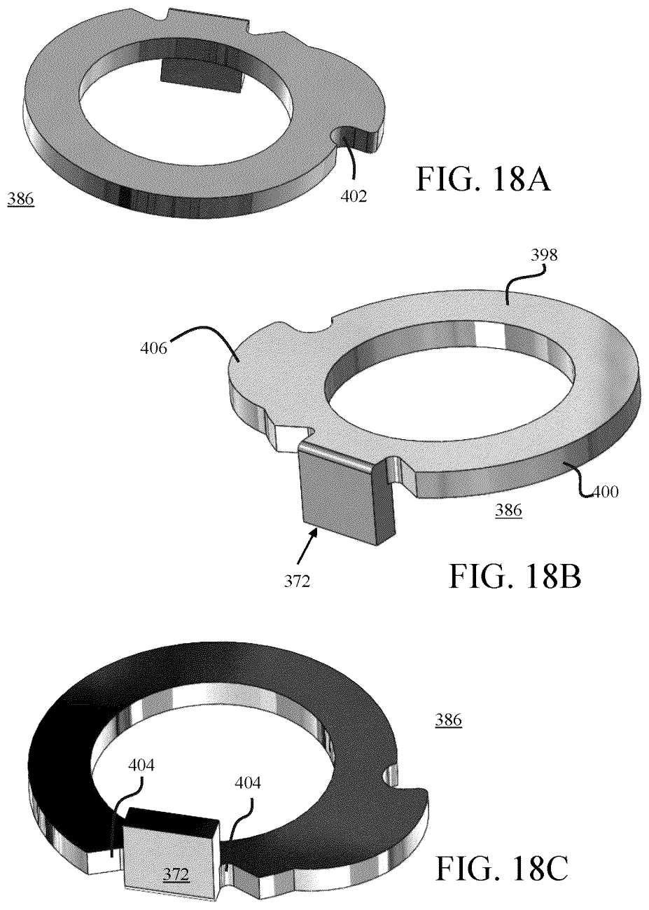

FIGS. 12A to 20E are non-limiting, exemplary illustrations of a lock device that uses a universal lock cylinder in accordance with another embodiment of the present invention, which may be used with non-hidden shackle or simply, padlock type lock devices. Universal lock cylinder 284 illustrated in FIGS. 12A to 20E includes similar corresponding or equivalent components, methods, interconnections, functional, operational, and or cooperative relationships as universal lock cylinder 100 and 270 that are shown in FIGS. 1A to 11R, and described above. Therefore, for the sake of brevity, clarity, convenience, and to avoid duplication, the general description of FIGS. 12A to 20E will not repeat every corresponding or equivalent component, methods, interconnections, functional, operational, and or cooperative relationships that has already been described above in relation to universal lock cylinders 100 and 270 that are shown in FIGS. 1A to 11R but instead, are incorporated by reference herein.

FIGS. 12A to 12D are non-limiting, exemplary illustrations of a lock device 282 in a form of a padlock comprising a universal lock cylinder 284 that includes a housing 286 with an integral rotating disc-detainer 288 and a shackle assembly 292 with a non-hidden shackle 290.

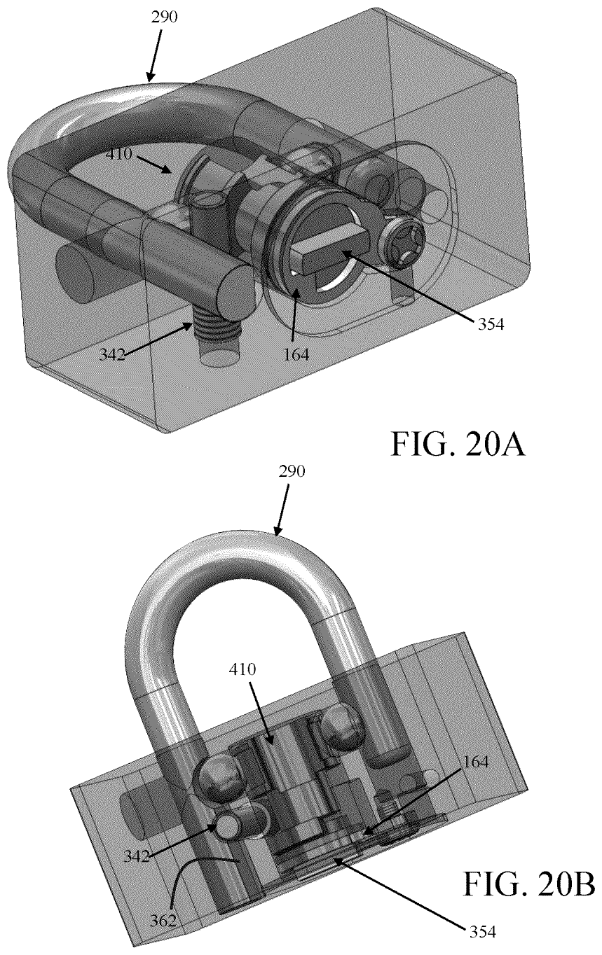

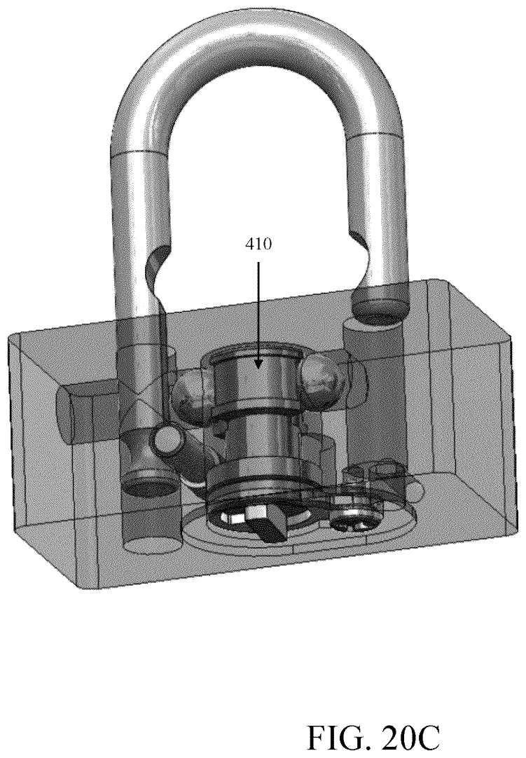

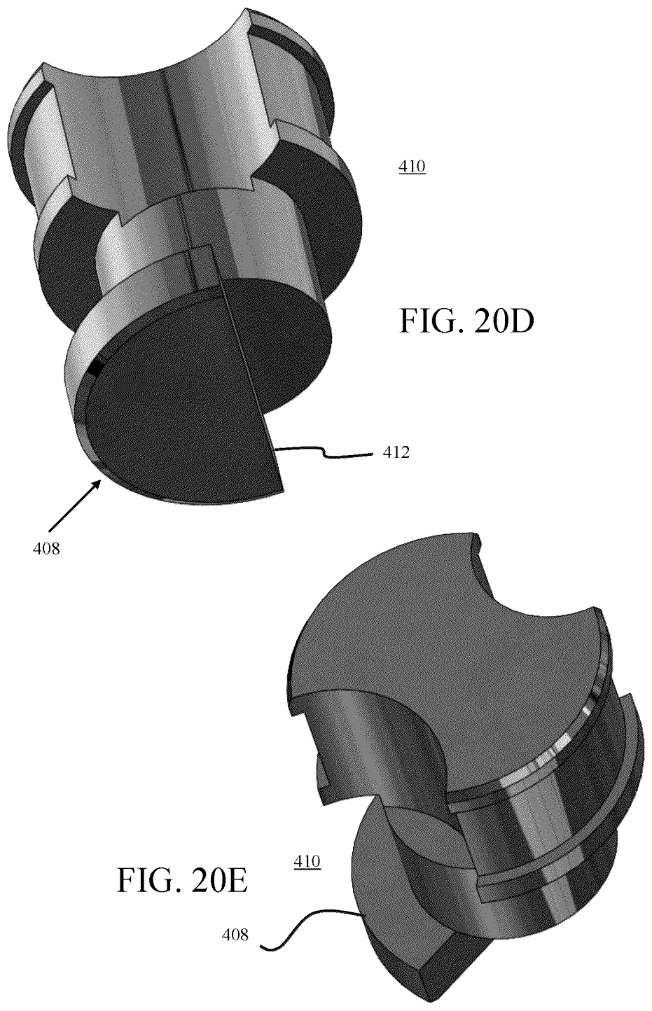

In this non-limiting, exemplary embodiment, universal lock cylinder 284 may be used as a non-key-retaining lock (FIGS. 12A to 19B) or a key retaining (FIGS. 20A to 20E).

As further detailed below, a non-key retaining lock means that key 108 may be removed after unlocking padlock 282 (as shown in FIGS. 12A to 19B) and a key retaining lock (FIGS. 20A to 20E) is one where key 108 remains within lock device after unlocking padlock 282.

As illustrated in FIGS. 12A to 12D, key 108 may be inserted into universal lock cylinder 284 of padlock 282, rotated to unlock padlock 282, and simply be removed after the unlocking operation (if lock is a non-key retaining otherwise, key 108 would remain within padlock 282 after the unlocking operation).

The universality feature or aspect of universal lock cylinder 284 for this embodiment allows the same universal lock cylinder 284 to be associated with different sized padlock casings 294 and or different sized shackles 290 in addition to being used with both key-retaining and non-key-retaining locks. For example, the sizes of shackles 290 (and hence, corresponding shackle openings 302 and 332 on casing 294 that accommodate shackle 290) may be varied, including the cross-sectional diameter (or thickness) of shackle 290 without having to use different lock cylinders for each different sized/shape shackle 290. As another example, casings 294 may be of different size or shape so long as the case cylinder retainer opening 296 continues to be configured commensurate with housing 286 of universal lock cylinder 284. The use of the same universal cylinder lock 284 with key-retaining and non-key-retaining lock are further detailed below.

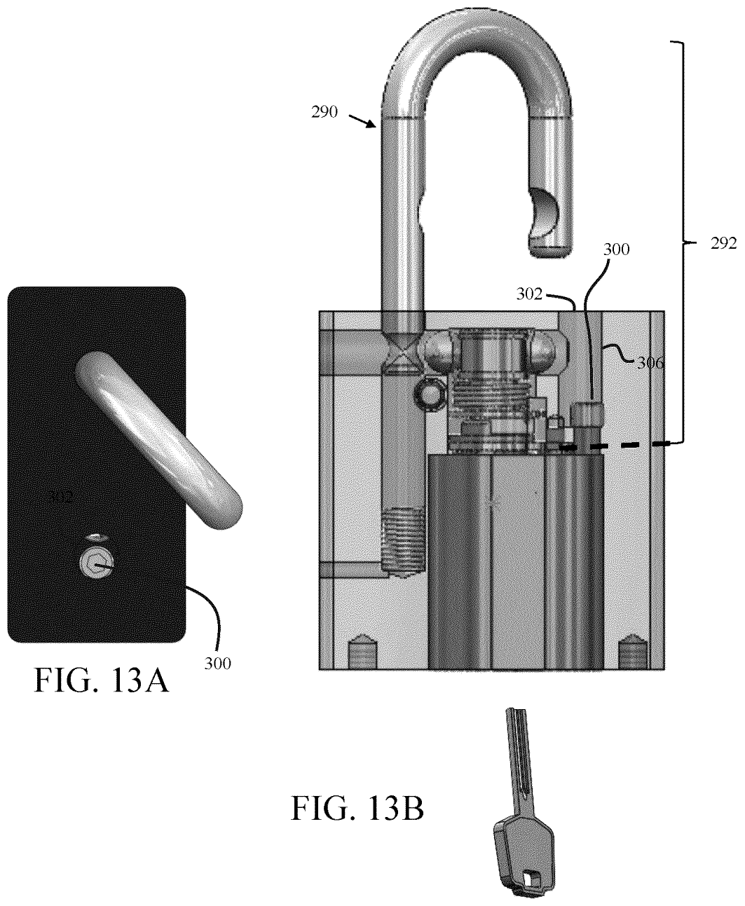

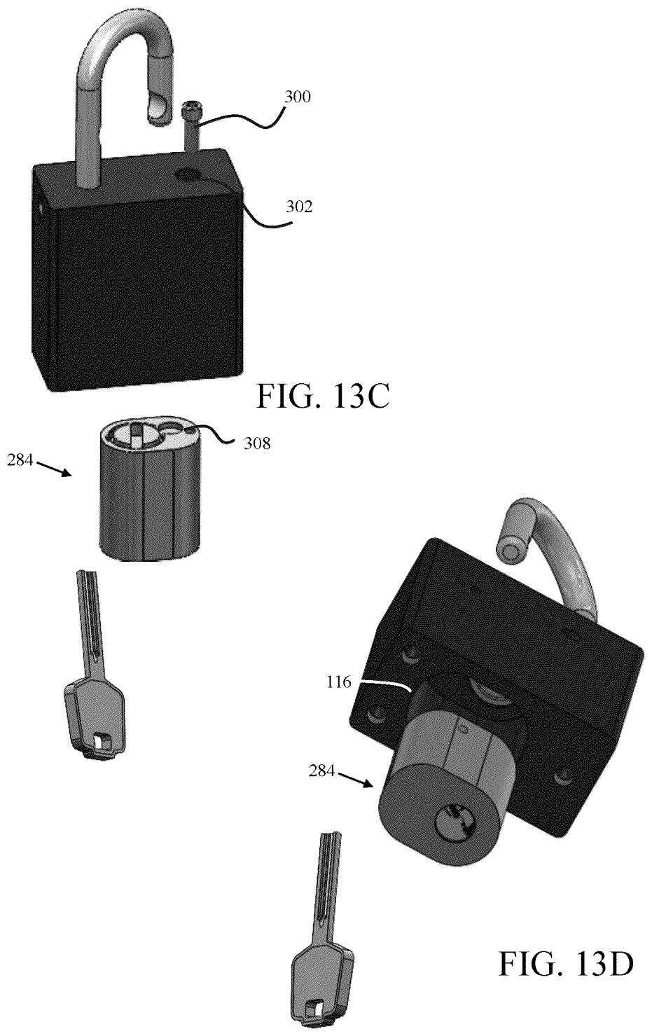

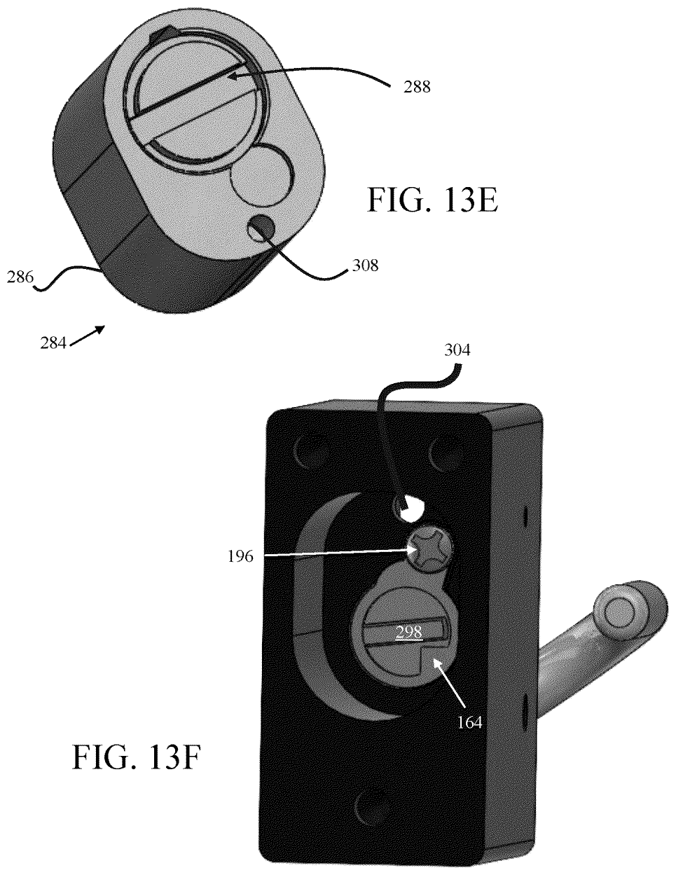

As illustrated in FIGS. 12A to 13F, in this embodiment, the illustrated lock device 282 is a padlock with a universal lock cylinder 284 that is isolated from a shackle assembly 292.

In this embodiment, universal lock cylinder 284 and shackle assembly 292 operatively engage one another by an interface (further detailed below). By isolating universal lock cylinder 284 from shackle assembly 292 while providing commensurate interface between the two in accordance with the present invention allows for the universality feature or aspect of universal lock cylinder 284 as all that would be required is a commensurate interface between shackle assembly 292 and that of universal lock cylinder 284.

As further detailed below, the commensurate interfaces include a cylinder engagement interface 288 of universal lock cylinder 284 and a shackle assembly engagement interface 298 of shackle assembly 292 wherein cylinder engagement interface 288 engages shackle assembly engagement interface 298.

As further illustrated in FIGS. 13A to 13F, universal locking cylinder 284 is detachably fixed to casing 294 of the lock device 282 by a cylinder retaining fastener 300.

Casing 294 includes cylinder retaining opening 304 within orifice 306 of short-side shackle opening 302 that aligns with a cylinder fastener opening 308 of universal locking cylinder 284 to receive cylinder retaining fastener 300.

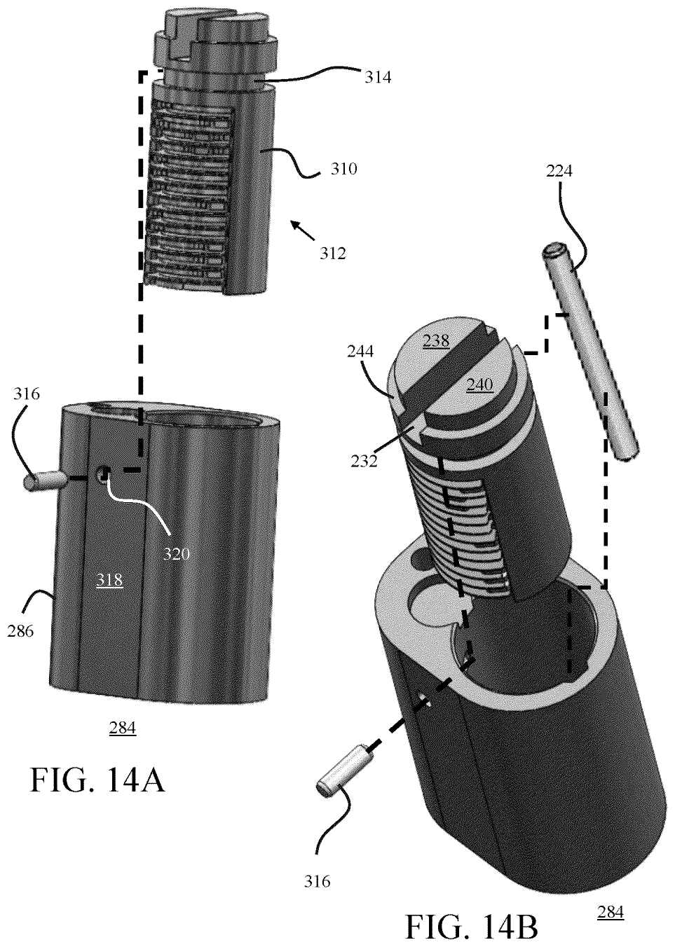

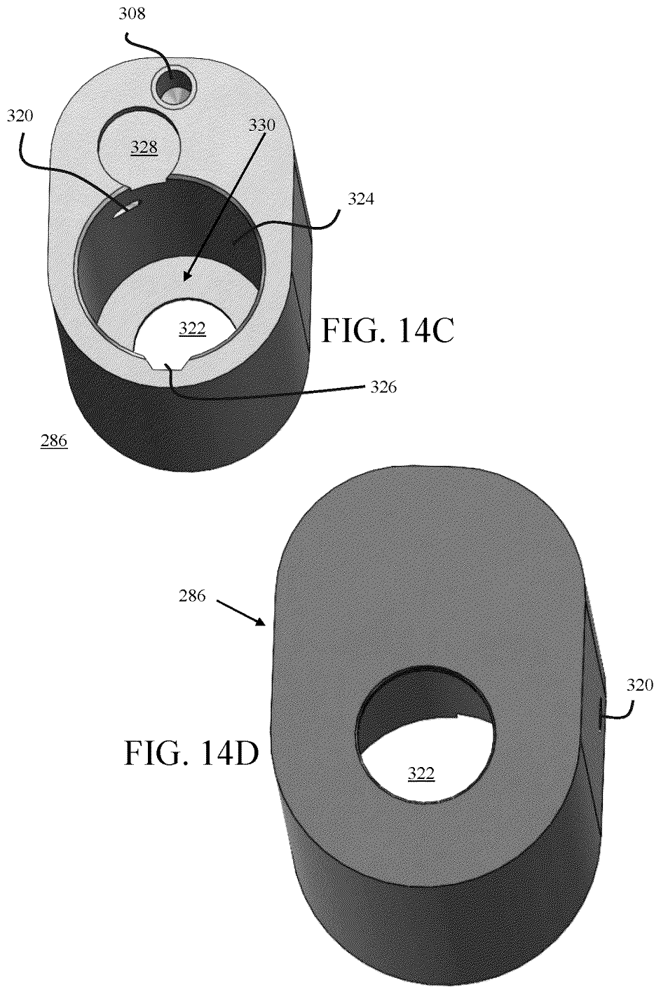

Referring to FIGS. 14A to 14D, a plug 310 of a rotating disc detainer 312 of universal lock cylinder 284 is comprised of a circumferentially recessed surface 314 for securing rotating disc detainer 312 within a housing 286 of universal lock cylinder 284. It should be noted that the structure of plug 312 above circumferentially recessed surface 314 is identical to plug 223 shown in FIGS. 8A to 8P.

Circumferentially recessed surface 314 of plug 310 receives a fastener (or pin) 316 for securing rotating disc detainer 312 within housing 286 of universal lock cylinder 284.

A lateral side 318 of housing 286 of universal lock cylinder 284 includes an RDD securing opening 320 through and by which fastener 316 secures rotating disc detainer 312. In this non-limiting, exemplary embodiment, fastener 316 is a pin that is friction-fit within the RDD securing opening 320.

Housing 286 of universal lock cylinder 284 is comprised of a key opening 322, and has a recessed cavity 324 within which RDD 312 is housed. The key opening 322 is defined by an annular base 330 where offset surface 244 of plug 310 rests.

Further included is a lateral, interior recess relief 326 for locking bar 224, and a recess relief 328 for stopper screw 196. Also illustrated in FIG. 14C is fastener opening 308 for securing housing 286 to casing 294.

As illustrated in FIGS. 12A to 15E, in this embodiment the shackle assembly 292 is integral with casing 294 of the lock device 282. Casing 294 is comprised of a short-side shackle opening 302 and a long-side shackle opening 332 on a top surface 334.

Further included is a long-side drainage opening 336 near the long-side shackle opening 332, and a short-side drainage opening 338 near short-side shackle opening 302. Both drainage openings allow accumulated water within lock device 282 to drain out to thereby prevent potential rusting of lock device 282.

Further included is threaded shackle retaining opening 340 that receive fastener 342 for securing a long-side 344 of shackle 292. As detailed below, long side 344 of shackle 290 when unlocked, is forced out (or lifted) by a shackle resilient member 346 and hence, fastener 342 is required to prevent shackle 290 from popping out of casing 294 entirely.

As further illustrated in FIGS. 12A to 19B, shackle assembly 292 is comprised of a shackle 290 and shackle resilient member 346 associated shackle 292 that lifts shackle 292 from locked position to an unlocked position.

Further included is a retainer member 342 that prevents shackle 292 from moving out of casing 294 of lock device 282 due to a restoring force exerted by shackle resilient member 346. A set of interlocking projections 348 (ball bearings) are further included that interlock with commensurate set of interlocking shackle recesses 350 that lock shackle 292 in a lock position. Shackle assembly 290 is further comprised of an actuator assembly 352, a driver 354, and a stopper 164.

Shackle 290 is comprised of a long side 344 that includes a distal end 356 having flat surface 358 that engages shackle resilient member 346. Shackle 290 also includes a circumferentially recessed portion 360 that engages retainer member (fastener) 342.

A flat recessed section 362 of shackle 290 defines a relief from retainer member 342 to allow for longitudinal movement of shackle 290 from a locked position to an unlock position and vice versa. Further included is a short side 364 of shackle within its own interlocking shackle recess 350.

Actuator assembly 352 for non-key retaining lock devices 282 of shackle assembly 292 is comprised of an actuator 364, an actuator resilient member 366 in a form of a torsion spring, and a limiter plate 368.

The rest state of actuator resilient member 366 is at an offset-rest state (or rest-reference point) when actuator 364 is in a locked position because even at this “rest” position there is minor tension on the spring. Limiter plate 368 functions to limit rotation of actuator 364 and allows for limited tension on actuator resilient member 366 even when in “rest” state.

As best shown in FIGS. 16A to 16D and 161-1 to 161-3, actuator assembly 352 shown is at a lock position, with actuator resilient member 366 at offset-rest state (or rest-reference point as it still has minor tension) for retaining the limiter plate 368.

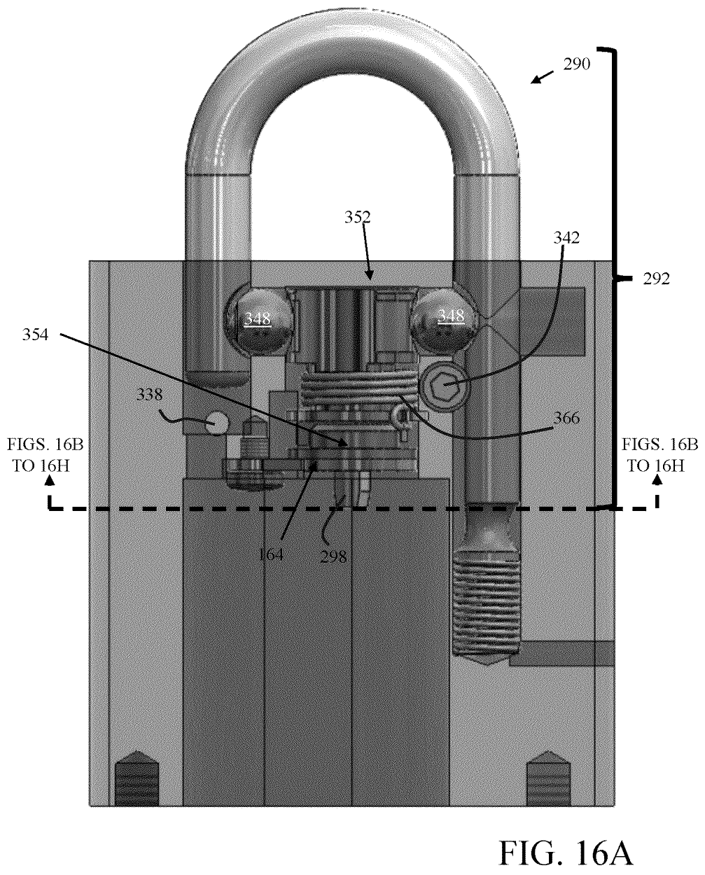

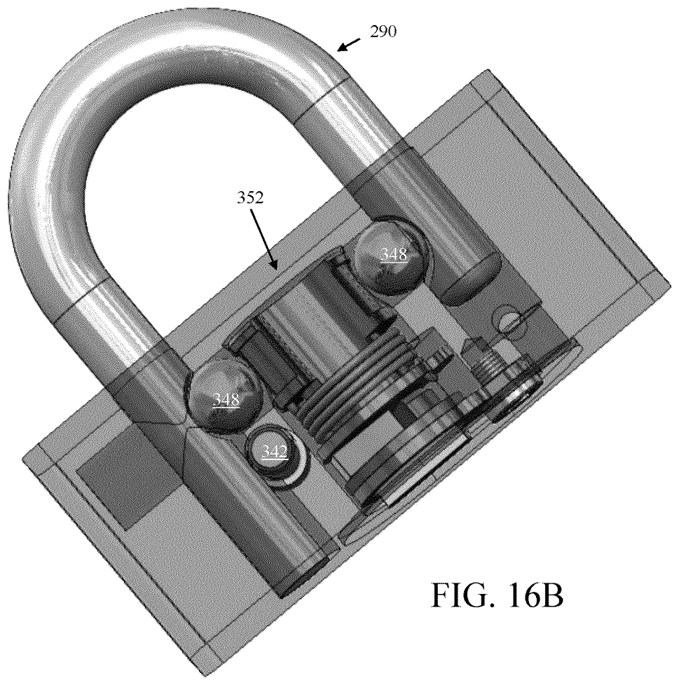

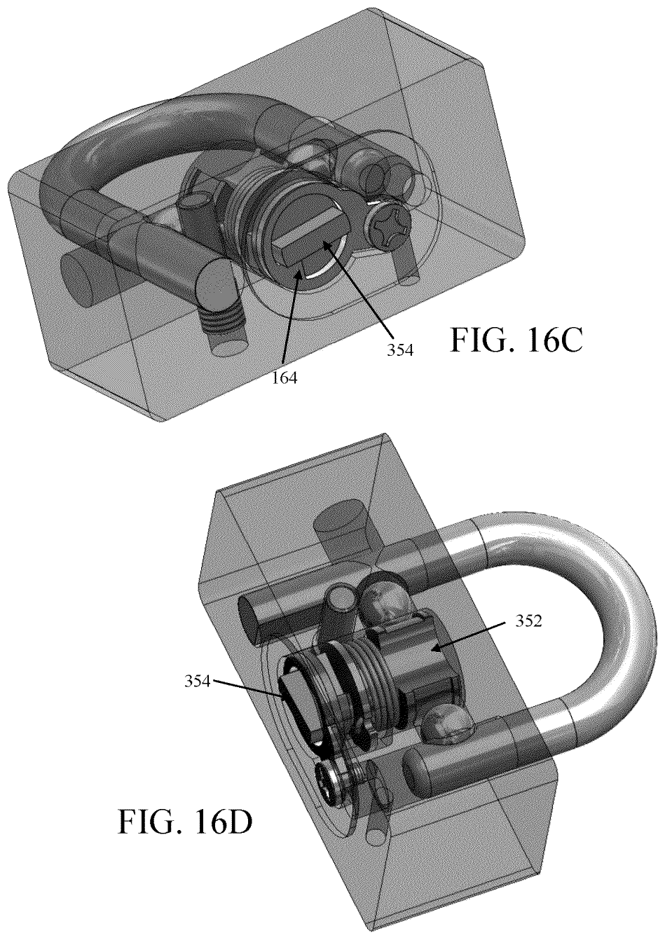

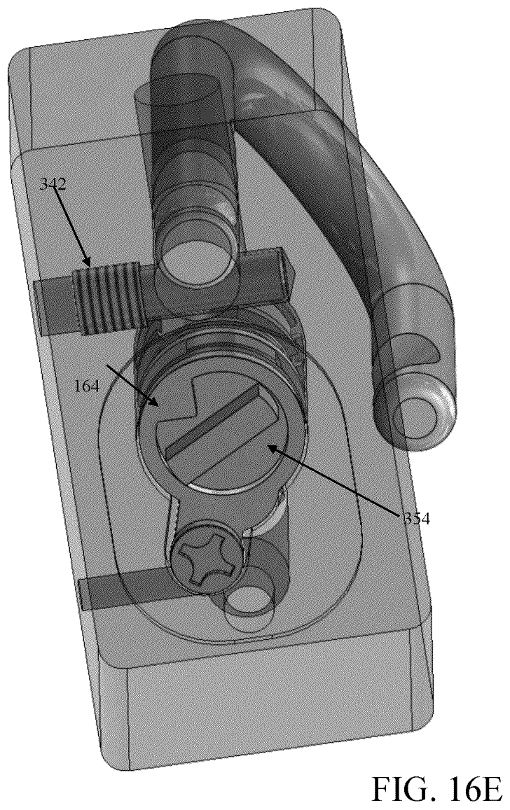

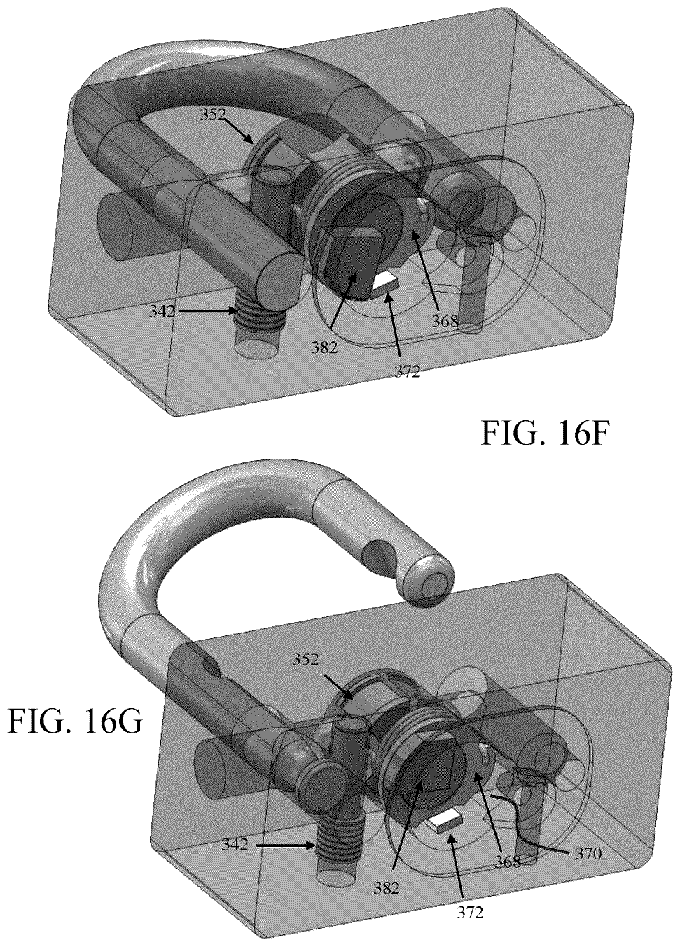

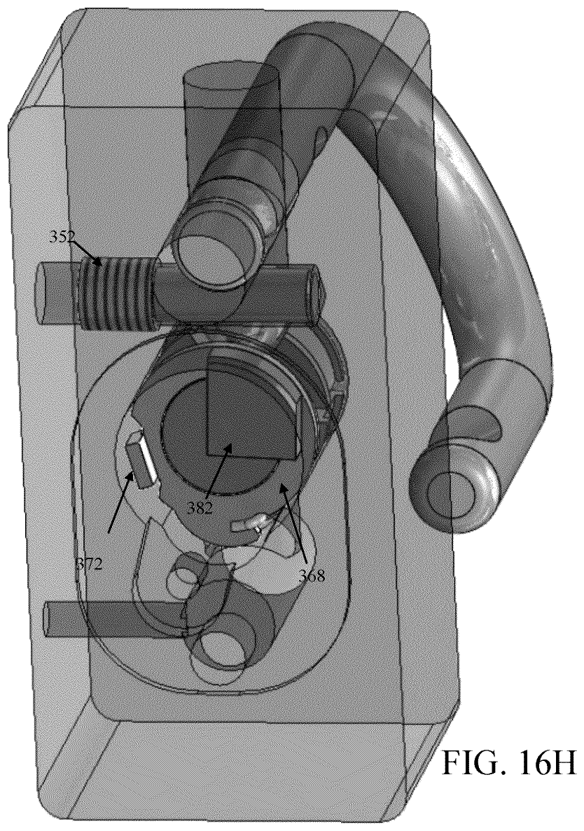

When rotated to an unlock position (FIGS. 16E to 16H), driver 354 rotates actuator 364 which, in turn, places actuator resilient member 366 (torsion spring) under tension. It should be noted that limiter plate 368 does not rotate with actuator 364 as it is snug fit and held in place within cavity 370 of casing 294.

Since limiter plate 368 does not rotate, the applied external force from key 108 to unlock is absorbed as torque by actuator resilient member 366. The absorbed torque (in a form of a torsion spring tension) built or generated within actuator resilient member 366 allows actuator 364 (via stop-tab 372 of limiter plate 368) to rotate (spin or snap) back to locked position when shackle 290 is moved into its locked position, which allows user to remove key 108 for non-key retaining lock device.

As best illustrated in FIGS. 161-1 to 17E, actuator 364 is comprised of an engagement section 374 that engages with and actuates a pair of locking ball bearing 348. Engagement section 374 further includes a recessed slot 376 within which an end 378 of actuator resilient member 366 rests.

Actuator 364 further includes a retaining portion 380 that houses actuator resilient member 366 and limiter plate 368, and a drive section 382 that engages a driver 354.

Engagement section 374 of actuator 364 is comprised of a cylindrical body 384 with recessed concave sections 386 that form diagonally opposite reliefs, with slot 376 of engagement section 374 positioned at a convex section 388 of the cylindrical body 384. The overall diameter of the cylindrical body 384 is greater than the overall diameter of retainer portion 380.

Convex sections 388 of cylindrical body 384 further include upper and lower flanges 390 that function to guide the pair of locking ball bearings 348 to move laterally and prevent vertical movements thereof.

For non-key retaining locks, drive section 382 of actuator 364 is comprised of a quarter disc (one-fourth of a circle) with a drive edge 392 that engages a driver side 394 of driver 354 and stop-tab 372 of the limiter plate 368.

Diameter of the drive section 382 is equal to the diameter of the cylindrical body 384 (but greater than retaining portion 380) and hence, a portion of limiter plate 368 rests on a top surface 396 of drive section 382.

Engagement of the stop-tab 372 with drive edge 392 when under force of actuator resilient member 366, including the contacting top surface 396 of drive section 382 retains limiter plate 386 in place otherwise, it would fall off actuator 364.

As best illustrated in FIGS. 161-1 to 161-3 and 18A to 18C, limiter plate 386 of the actuator assembly 352 is comprised of an annular body 398 with a periphery 400 that includes a recess configured as a hook 402 that receives a second end 404 of actuator resilient member 366.

Further included is stop-tab 372 for stopping further rotation of actuator 364, with the stop-tab 372 substantially oriented perpendicular to annular body 398 of limiter plate 386. Further included are bending reliefs 404 to allow for stop-tab 372 bending to occur.

Periphery 400 of limiter plate 386 near hook 402 includes a protruded (or bulging) section 406 that mates with inner walls of cavity 370 of casing 294, maintaining limiter plate 386 from moving.

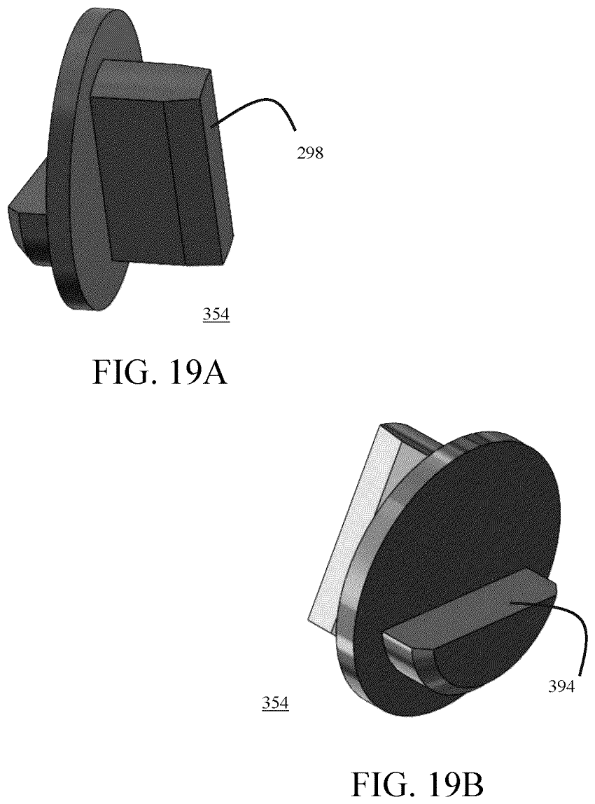

A driver 354 of shackle assembly 292 is shown in FIGS. 19A and 19B and is comprised of a shackle assembly engagement interface 298 that interfaces and engages universal lock cylinder engagement interface 288, and a drive side 394 that moves actuator assembly 352 when driver 354 is moved by universal lock cylinder 284.

FIGS. 20A to 20E are non-limiting, exemplary illustrations of a key-retaining lock device. Key retaining lock devices (FIGS. 20A to 20E) and non-key retaining lock devices (FIGS. 12A to 19B) include similar corresponding or equivalent components, methods, interconnections, functional, operational, and or cooperative relationships. Therefore, for the sake of brevity, clarity, convenience, and to avoid duplication, the general description of FIGS. 20A to 20E will not repeat every corresponding or equivalent component, methods, interconnections, functional, operational, and or cooperative relationships that have already been described above in relation to non-key retaining devices shown in FIGS. 12A to 19B but instead, are incorporated by reference herein.

For key retaining locks, there is no actuator resilient member 366 and hence, no need for a limiter plate 386 and no need for a slot 376 to receive one end 378 of actuator resilient member 386. Instead, drive section 408 of actuator 410 is comprised of a half-disc (one-half of a circle) with a drive edge 412 that engages a driver side 394 of a driver 354.

Since actuator 410 remains in the unlock position and is not forced back into locked position as there is no spring to force it back, key 108 will continue to remain in the lock until shackle 290 is moved to locked position and key 108 is rotated back to lock position at which point, the key 108 may be removed.

It should be noted that since both drive section 408 of actuator 410 and driver side 394 of a driver 354 are semi-circular discs, there is no room for actuator 410 to move as they are always in full engagement and hence, rotating driver 354 (via key 108) will rotate actuator 410.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, inside, outside, bottom, forward, reverse, clockwise, counter clockwise, up, down, or other similar terms such as upper, lower, aft, fore, vertical, horizontal, lateral, oblique, proximal, distal, parallel, perpendicular, transverse, longitudinal, etc. have been used for convenience purposes only and are not intended to imply any particular fixed direction, orientation, or position. Instead, they are used to reflect relative locations/positions and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

Further the terms “a” and “an” throughout the disclosure (and in particular, claims) do not denote a limitation of quantity, but rather denote the presence of at least one of the referenced item.

The use of the phrases “and or,” “and/or” throughout the specification (if any used) indicate an inclusive “or” where for example, A and or B should be interpreted as “A,” “B,” or both “A and B.”

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A lock device, comprising:
a universal lock cylinder that is self-contained and includes:
a housing with an integral rotating disc-detainer.

2. The lock device as set forth in claim 1, wherein:
the universal lock cylinder is detachably associated with a protective lock casing.

3. The lock device as set forth in claim 1, wherein:
the universal lock cylinder is interchangeable with different cylinder forms having different cylinder technologies in relation to a protective lock casing.

4. The lock device as set forth in claim 1, wherein:
an outer surface of the housing of the universal lock cylinder is configured commensurate with an inner surface of a case cylinder retainer opening of a protective lock casing.

5. The lock device as set forth in claim 1, wherein:
the universal lock cylinder further includes a shackle.

6. A lock device, comprising:
a universal lock cylinder that includes:
a housing with an integral rotating disc-detainer.

7. The lock device as set forth in claim 6, wherein:
the housing of the universal lock cylinder is comprised of a first piece and a second piece.

8. The lock device as set forth in claim 6, wherein:
an overall height and a width of the housing is configured commensurate with an overall corresponding depth and width of a case cylinder retainer opening.

9. The lock device as set forth in claim 6, wherein:
the housing is comprised of:
at least one fastener openings for a fastener that secures the first and the second pieces together to form the housing.

10. The lock device as set forth in claim 6, wherein:
the housing is further comprised of:
a top side that has a shackle opening through which a shackle of the universal lock cylinder extends; and
a bottom side that has a key opening for insertion of a lock key.

11. The lock device as set forth in claim 6, wherein:
an outer surface of the housing is comprised of:
a retainer recessed cavity with a first distal end wall of the cavity used for preventing the universal lock cylinder from being removed from the case cylinder retainer opening;
the retainer recessed cavity has a second distal end wall used for preventing the universal lock cylinder from moving too far into the case cylinder retainer opening of the protective lock casing.

12. The lock device as set forth in claim 6, wherein:
an outer surface of the housing is comprised of:
a partially extending flat recessed section for additional mating compatibility with a protective lock casing that has a corresponding, partially extending flat projection section within a case cylinder retainer opening.

13. A lock device, comprising:
a universal lock cylinder that includes:
a housing with an integral rotating disc-detainer and shackle.

14. The lock device as set forth in claim 13, wherein:
the housing is comprised of a first piece and a second piece that are fixedly connected by a set of fasteners using lock washers.

15. The lock device as set forth in claim 14, wherein:
the first piece of the housing is comprised of a first piece engagement side that engages a second piece engagement side of the second piece.

16. The lock device as set forth in claim 14, wherein:
a set of alignment plugs are used to align the first and the second pieces of the housing for connection.

17. The lock device as set forth in claim 14, wherein:
the first piece engagement side of the first piece is comprised of:
at least one through-hole constituting a fastener opening for a fastener that secures the first and the second pieces together to form the housing.

18. The lock device as set forth in claim 14, wherein:
the first piece engagement side of the first piece is comprised of:
at least one blind-hole for receiving a first distal ends of a set of alignment plugs used to align the first and the second pieces for connection.

19. The lock device as set forth in claim 14, wherein:
the first piece engagement side of the first piece is further comprised of:
a shackle opening through which an integral shackle of the universal lock cylinder extends.

20. The lock device as set forth in claim 14, wherein:
the first piece engagement side is comprised of recessed sections for securely housing components;
a first recessed section is for the shackle; a second recessed section is for a stopper; and a third recessed section is for the rotating disc-detainer.

21. The lock device as set forth in claim 13, wherein:
a securing portion of the shackle is integrated within a first piece of the housing, with a locking portion of the shackle extending through a shackle opening of the first piece of the housing.

22. The lock device as set forth in claim 13, wherein:
the locking portion of the shackle is comprised of locking configuration.

23. The lock device as set forth in claim 13, wherein:
a securing distal end of a securing portion of the shackle is associated with the rotating disc detainer.

24. The lock device as set forth in claim 21, wherein:
the securing portion includes a circular flange that extends transversally, perpendicular to a longitudinal axis of the shackle.

25. The lock device as set forth in claim 13, wherein:
a first and lateral sides of a circular flange of a securing portion of the shackle are received within a correspondingly configured first recessed section of a first piece of the housing, thus preventing the shackle from sliding out of the housing.

26. The lock device as set forth in claim 13, wherein:
a second side of a circular flange of a securing portion of the shackle, opposite a first side, is stopped from moving by a stopper, thus preventing the shackle from moving from a first piece of the housing and into a second piece of the housing.

27. The lock device as set forth in claim 14, wherein:
the second recessed sections include:
a stopper recessed portion having a silhouette configured commensurate with a corresponding outer periphery of the stopper.

28. The lock device as set forth in claim 27, wherein:
the stopper recessed portion further includes a blind-hole for a fastener for securing the stopper.

29. The lock device as set forth in claim 13, wherein:
the rotating disc detainer is comprised of:
a plug that includes:
an engagement portion with an enclosure surface having an interlocking recess that interlocks with a corresponding interlocking projection of a securing distal end of a securing portion of the shackle.

30. The lock device as set forth in claim 29, wherein:
the engagement portion is comprised of:
a first offset surface defined by semi-circular discs projections;
a second offset surface, below the first offset surface;
the second offset surface defines a semi-annular recess section, surrounding the semi-circular discs projections; and
the interlocking recess that extends parallel a full length of a diameter of the enclosure surface, defining a third offset surface in a form of a slot which extends below the semi-annular recess section.

31. The lock device as set forth in claim 15, wherein:
the second piece engagement side of the second piece includes:
a set of alignment plugs that are used to align the first and the second pieces of the housing for connection.

32. The lock device as set forth in claim 15, wherein:
the second piece engagement side of the second piece is comprised of:
at least one threaded blind-hole constituting a fastener opening for a fastener that secures the first and the second pieces together to form the housing.

33. The lock device as set forth in claim 15, wherein:
the second piece engagement side of the second piece is comprised of:
at least one blind-hole for receiving a second distal ends of a set of alignment plugs used to align the first and the second pieces for connection.

34. The lock device as set forth in claim 15, wherein:
the second piece engagement side of the second piece is comprised of:
a key-opening through which a lock key of the universal lock cylinder may be inserted into the rotating disc detainer.

35. The lock device as set forth in claim 13, wherein:
a key-insertion end of the rotating disc detainer is comprised of a key insertion opening that is aligned with the key-opening.

36. The lock device as set forth in claim 35, wherein:
the key-opening is defined by a recessed annular section having an annular flange and wall, with a section of the wall recessed to accommodate a locking bar of the plug.

37. The lock device as set forth in claim 13, wherein:
the shackle is comprised of:
a lock portion:
having an elongated configuration with a semi-circular profile;
the semi-circular profile has a general crescent shape with a recess portion for receiving a locking ball, while an opposite section to the recess portion pushes the locking ball into a circumferential locking groove of a locking pin; and
a securing portion that is identical to the securing portion of the above descried shackle.

38. A lock device, comprising:
a universal lock cylinder that is isolated from a shackle assembly;
wherein: the universal lock cylinder engages the shackle assembly by an interface.

39. The lock device as set forth in claim 38, wherein:
the interface includes:
a cylinder engagement interface of the universal lock cylinder; and
a shackle engagement interface of the shackle assembly;
wherein: the cylinder engagement interface engages the shackle engagement interface.

40. The lock device as set forth in claim 38, wherein:
lock device is one of a non-retaining key locking device.

41. The lock device as set forth in claim 38, wherein:
lock device is a key-retaining locking device.

42. The lock device as set forth in claim 38, wherein:
the universal locking cylinder is detachably fixed to a casing.

43. The lock device as set forth in claim 42, wherein:
a plug of a rotating disc detainer of the universal lock cylinder is comprised of a circumferentially recessed surface for securing the rotating disc detainer within a housing of the universal lock cylinder.

44. The lock device as set forth in claim 43, wherein:
the circumferentially recessed surface of the plug receives a fastener for securing the rotating disc detainer within housing of the universal lock cylinder.

45. The lock device as set forth in claim 44, wherein:
a lateral side of the housing of the universal lock cylinder includes a Rotating Disc Detainer (RDD) securing opening through and by which the fastener secures the rotating disc detainer.

46. The lock device as set forth in claim 38, wherein:
a housing of the universal lock cylinder is comprised of:
a key opening;
a cavity within which the RDD is housed;
an RDD securing opening;
a lateral, interior recess relief for locking bar;
Recess relief for stopper screw;
Fastener opening for securing housing to casing.

47. The lock device as set forth in claim 38, further comprising:
a casing having:
a short-side shackle opening and a long-side shackle opening on a top surface of the casing;
a long-side drainage opening near the long-side shackle opening;
a short-side drainage opening near the short-side shackle opening; and
a threaded shackle retaining opening that receive a fastener for securing a long-side of the shackle.

48. The lock device as set forth in claim 38, wherein:
the shackle assembly is comprised of:
a shackle;
a shackle resilient member associated the shackle;
a retainer member that prevents the shackle from moving out of a casing of the lock device due to a restoring force exerted by the shackle resilient member;
a set of interlocking projections that interlock with commensurate set of interlocking shackle recesses that lock the shackle in a lock position;
actuator assembly;
a driver; and
stopper plate.

49. The lock device as set forth in claim 48, wherein:
the actuator assembly is comprised of:
an actuator;
an actuator resilient member; and
a limiter plate.

50. The lock device as set forth in claim 38, wherein:
the shackle assembly is comprised of:
a shackle;
a shackle resilient member associated the shackle;
a retainer member that prevents the shackle from moving out of a casing of the lock device due to a restoring force exerted by the shackle resilient member;
a set of interlocking projections that interlock with commensurate set of interlocking shackle recesses that lock the shackle in a lock position; actuator assembly; and
an actuator.

51. The lock device as set forth in claim 49, wherein:
the actuator is comprised of:
an engagement section that engages with and actuates a pair of locking ball bearings; the engagement section further includes a slot within which an end of an actuator resilient member rests;
a retaining portion that houses the actuator resilient member and the limiter plate; and
a drive section that engages a driver of the lock section.

52. The lock device as set forth in claim 51, wherein:
the engagement section of the actuator is comprised of:
a cylindrical body with recessed concave sections that form diagonally opposite reliefs, with the slot of the engagement section positioned at a convex section of the cylindrical body.

53. The lock device as set forth in claim 51, wherein:
drive section is comprised of:
a quarter disc with a drive edge that engages a driver side of a driver and a stopper edge that engages a tap of the limiter plate.

54. The lock device as set forth in claim 50, further comprising:
drive section is comprised of:
a half disc with a drive edge that engages a driver side of a driver.

55. The lock device as set forth in claim 49, wherein:
the limiter plate is comprised of:
an annular body with a periphery that includes:
a recess that receives a first end of an actuator resilient member; and
a tab for stopping further rotation of the actuator, with the tab substantially oriented perpendicular to the annular body of the limiter plate.

56. A universal lock cylinder, comprising:
a housing comprised of a first piece and a second piece that houses:
a shackle; and
an integral rotating disc detainer.

57. A universal lock cylinder, comprising:
a housing that accommodates a rotating disc detainer.
